(19) United States
(12) Patent Application Publication
(10) Pub. No.: US 2005/0263008 A1
(43) Pub. Date: Dec. 1, 2005

(54) Soup supplying apparatus

(75) Inventors: Tadashi Nagasaki, Tokyo (JP); Masahiro Matsumoto, Tokyo (JP); Masahiro Kato, Tokyo (JP); Takayuki Muraki, Tokyo (JP)

Correspondence Address: PEARNE & GORDON LLP, 1801 EAST 9TH STREET, SUITE 1200, CLEVELAND, OH, 44114-3108, US

(73) Assignee: Fuji Electric Retail Systems Co., Ltd., Tokyo (JP)

(21) Appl. No.: 11/027,249

(22) Filed: Dec. 30, 2004

(30) Foreign Application Priority Data
May 25, 2004 (JP) P2004-154883
May 31, 2004 (JP) P2004-160822

(51) Int. Cl. A23L 1/00

(52) U.S. Cl. 99/348

(57) ABSTRACT

A soup supplying apparatus includes: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device. The controller controls the driving device to move the ladle mechanism to reciprocatively slide between predetermined positions on the inner periphery of the vessel when in a mode of not pouring out the soup, and controls the driving device to vary speed of the movement of the ladle mechanism in accordance with a kind of the soup accommodated in the vessel.

### BACKGROUND OF THE INVENTION

1. Field of the Invention

The present invention relates to a soup supplying apparatus for supplying customers with a predetermined sub-divided quantity of soup such as stew, soup, curry and miso soup accommodated in a vessel.

2. Description of the Related Art

As disclosed in Japanese Patent No. 3449554, such a previously known soup supplying apparatus is one in which sub-divided predetermined quantities of soup containing ingredients (substance) accommodated in the vessel are distributed to eating utensils.

Another previously known soup supplying apparatus is one including a vessel having an arc-shaped inner periphery and an upper opening, a ladling mechanism which ladles out or scoop a soup while sliding over the inner periphery to the one end, and pours the soup ladled to the outside of the vessel through the upper opening at the above one end, and a driving device for providing a driving force for sliding or pouring to the ladle mechanism. The sliding portion of the ladling mechanism constitutes e.g. a ladle having a ladling mouth for the soup. The ladle is internally provided with a partitioning plate which where the soup is accommodated in the ladle, serves to accommodate the ingredients and soup liquid separately while passing the soup liquid. For the reason, the ladle can ladle or scoop the ingredients and the soup liquid in a predetermined ratio therebetween (hereinafter, the above-described sliding operation is referred to as “ladling sliding”). Further, at the upper opening of the vessel, a suitable ladle leaning means is provided. When the ladle reaches the upper opening, it is leaned by the ladle leaning means to pour out the soup inside itself into an eating utensil.

In order that the soup with a ratio between the ingredients and soup liquid being always kept constant can be sub-divided to the users, the ratio between the ingredients and the soup liquid in the entire soup must be as uniform prior to the sub-division. To the end, the soup supplying apparatus includes a controller for controlling a driving device in order to reciprocate the ladle on the inner periphery of the vessel e.g. between predetermined positions (hereinafter, the sliding operation is referred to as reciprocative sliding) or ladle-slide it. On the other hand, the controller, when it receives a supplying command for the soup, causes the ladle to slide to the one end of the inner periphery of the vessel by the driving force for the above reciprocative sliding or ladling-sliding. Namely, the soup stirred or ladled by the ladle within the vessel is sub-divided through the operation similar to the stirring or ladling by the ladle.

In order that the soup supplying apparatus permits the soup always kept at a constant temperature to be sub-divided to users, the temperature of the entire soup within the vessel must be as uniform as possible prior to the sub-division. Further, if the vessel is metallic, the temperature of the entire vessel is prone to be uniform so that the temperature of the soup is also prone to be uniform. However, there is a fear of burning/sticking of the soup at the interface between the inner periphery of the vessel and the soup. In order to sub-divide all the time the soup having a predetermined temperature and quantity of the ingredients to the users while preventing the burning/sticking, the soup supplying apparatus, e.g. in a mode where the soup is not poured (before the sub-division), is provided with a controller for controlling the driving device to slide the ladle reciprocatively between predetermined positions on the inner periphery. Thus, the soup within the vessel is stirred.

### SUMMARY OF THE INVENTION

However, when the conventional soup supplying apparatus as described above is adopted, it is difficult to sub-divide various kinds of soup in a state where the predetermined temperature and quantity of ingredients are always kept and no burning/sticking is produced.

For example, where the above stirring is performed equally for both the soup with more thickness and the soup with less thickness, the temperature of the soup with more thickness, through which heat is difficult to travel, may give lower uniformity for each vending than that of the soup with less thickness. Further, for example, for the soup with smaller ingredients, it is more difficult to maintain the ratio between the ingredients and soup liquid constant for each vending than for the soup with larger ingredients. Further, for example, where the above stirring is equally performed while the soup in the metallic vessel is heated to a predetermined temperature, at a low temperature at which burning/sticking is difficult to occur, the stirring may be excessively performed whereas at a high temperature at which burning/sticking is prone to occur the stirring may be performed insufficiently. Furthermore, there are some soups which are hard at a lower temperature and difficult to stir. In short, according to the kind of the soup or manner of heating thereof, the quality of the sub-divided soup may be deteriorated.

Some soups contain fine ingredients/dregs. Where the ladle slides towards the ladling mouth for such soups, the fine ingredients/dregs or extracts are likely to proceed into the inner part of the ladle. As a result, the ingredients/dregs or extracts may be deposited in the inner part of the ladle so that the quantity of the soup liquid within the ladle becomes relatively little. Even where the ladle has the partitioning plate as described above, these ingredients/dregs or extracts are likely to pass the partitioning plate. In addition, once they have proceeded in the inner part of the ladle, their flow in an opposite direction is obstructed by the partitioning plate so that they are difficult to be exhausted towards the ladling mouth. Thus, the quantity of the soup liquid within the ladle may be further reduced. This presents a problem that according to the kind of the soup, the quality of the sub-divided soup is deteriorated. On the other hand, in order to obviate such an inconvenience, it is necessary to remove the deposits within the ladle diligently by cleaning. However, the operation is troublesome.

In view of these problems, the present invention has been accomplished. One of objects of the invention is to sub-divide a soup while easily maintaining the quality thereof, irrespectively of the kind of the soup or manner of heating the soup.

From another aspect of view, when the conventional soup supplying apparatus as described above is adopted, it is difficult to sub-divide the soup so that the soup is not splashed while sufficiently stirring or ladling the soup. In order to sufficiently stir or ladle the soup, the driving force for making the reciprocative sliding or ladling-sliding of the ladle on the inner periphery of the vessel must be increased. On the other hand, where the ladle is slid to the one end of the inner periphery of the vessel by the driving force for the reciprocative sliding or ladling-sliding in the sub-division of the soup, a larger driving force for the reciprocative sliding or ladling-driving provides a larger inertial force which acts on the soup until the ladle stops in a short time. This presents a problem that the soup is likely to be splashed. When the soup is splashed, the quantity of the soup to be sub-divided into each eating utensil is not uniform for each vending. On the other hand, if the driving force for stirring or ladling is reduced in order to prevent the splash (hereinafter referred to as “restrain the stirring or ladling”), it is difficult to sub-divide the soup having a predetermined quantity of ingredients all the time.

The above contradictive problem between the stirring or ladling and sub-division of the soup becomes further serious according to the kind of the soup. For example, the soup with less thickness, when it suffers from the above inertial force in the sub-division, is likely to be splashed. On the other hand, if the stirring or ladling is restrained in order to prevent the splashing, the soup with more thickness may be insufficiently stirred or ladled.

Further, even when the soup supplying apparatus as described above is adopted, it is difficult to sub-divide the soup having a predetermined quantity of ingredients all the time for various soups. For example, it is assumed that for the soup with more thickness, the controller, when it receives a supplying command for the soup, slides the ladle located at a certain position on the inner periphery of the vessel at the time from the certain position to the one end of the vessel. In the case, for the soup in the area over which the ladle is not sliding after the supplying command has been received, the operation of the ladle is difficult to conduct through the soup with more thickness. This provides a fear of insufficient stirring or ladling. On the other hand, if the driving force for stirring or ladling is increased in order to solve the above problem, the soup with less thickness may be stirred or ladled excessively.

In short, a problem may be presented that the quantity or quality of the soup sub-divided is deteriorated according to the kind of the soup.

Some soups contain fine ingredients/dregs or extracts. Where the ladle slides towards the ladling mouth for such soups, the fine ingredients/dregs or extracts are likely to proceed into the inner part of the ladle. As a result, the ingredients/dregs or extracts may be deposited in the inner part of the ladle so that the quantity of the soup liquid within the ladle becomes relatively little. Even where the ladle has the partitioning plate as described above, these ingredients/dregs or extracts are likely to pass the partitioning plate. In addition, once they have proceeded in the inner part of the ladle, their flow in an opposite direction is obstructed by the partitioning plate so that they are difficult to be exhausted towards the ladling mouth. Thus, the quantity of the soup liquid within the ladle may be further reduced. This presents a problem that according to the kind of the soup, the quality of the sub-divided soup is deteriorated. On the other hand, in order to obviate such an inconvenience, it is necessary to remove the deposits within the ladle diligently by cleaning. However, the operation is troublesome.

In view of these problems, the present invention has been accomplished. Another one of the objects of the invention is to sub-divide a soup while easily maintaining the quantity and quality thereof, irrespectively of the kind of the soup.

According to a first aspect of the invention, there is provided a soup supplying apparatus including: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device, wherein the controller controls the driving device to move the ladle mechanism to reciprocatively slide between predetermined positions on the inner periphery of the vessel when in a mode of not pouring out the soup, and wherein the controller controls the driving device to vary speed of the movement of the ladle mechanism in accordance with a kind of the soup accommodated in the vessel.

According to a second aspect of the invention, there is provided a soup supplying apparatus including: a vessel that accommodates a soup and has an arc-shaped inner periphery and an upper opening formed at one end of the inner periphery, the vessel configured to be heatable; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device, wherein the controller controls the driving device to move the ladle mechanism to reciprocatively slide between predetermined positions on the inner periphery of the vessel when in a mode of not pouring out the soup, and wherein the controller controls the driving device to vary speed of the movement of the ladle mechanism in accordance with a temperature of the soup accommodated in the vessel when the vessel is heated.

According to a third aspect of the invention, there is provided a soup supplying apparatus including: a vessel that accommodates a soup and has an arc-shaped inner periphery and an upper opening formed at one end of the inner periphery, the vessel configured to be heatable; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device, wherein the controller controls the driving device to move the ladle mechanism to reciprocatively slide between predetermined positions on the inner periphery of the vessel when in a mode of not pouring out the soup, and wherein the controller controls the driving device to vary frequency of the movement of the ladle mechanism in accordance with a temperature of the soup accommodated in the vessel when the vessel is heated.

According to a fourth aspect of the invention, there is provided a soup supplying apparatus including: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device, wherein the controller controls the driving device to repeat a first and a second operations when in a mode of not pouring out the soup, the first operation in which to move the ladle mechanism to reciprocatively slide between predetermined positions on the inner periphery of the vessel, the second operation in which to move the ladle mechanism to move the ladle mechanism toward the other end of the inner periphery outside the predetermined positions.

According to a fifth aspect of the invention, there is provided a soup supplying apparatus including: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device to supply to the ladle mechanism a first driving force for reciprocatively sliding the ladle mechanism between predetermined positions on the inner periphery of the vessel, and a second driving force for moving the ladle mechanism to pour out the soup from the vessel, wherein the second driving force is configured to be smaller than the first driving force.

According to a sixth aspect of the invention, there is provided a soup supplying apparatus including: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device to supply to the ladle mechanism a first driving force for reciprocatively sliding the ladle mechanism between predetermined positions on the inner periphery of the vessel, and a second driving force for moving the ladle mechanism to pour out the soup from the vessel, wherein the controller controls the driving device to reduce the first driving force as the ladle mechanism approaches the one end of the inner periphery of the vessel.

According to a seventh aspect of the invention, there is provided a soup supplying apparatus including: a vessel that accommodates a soup and has an arc-shaped inner periphery and an upper opening formed at one end of the inner periphery; a ladle mechanism that ladles up the soup accommodated in the vessel by slidably moving along the inner periphery towards the upper opening and pours the soup out from the vessel through the upper opening; a driving device that supplies a driving force to the ladle mechanism; and a controller that controls the driving device to move the ladle mechanism towards the other end of the inner periphery before moving the ladle mechanism towards the one end when a command to supply the soup is input.

### BRIEF DESCRIPTION OF THE DRAWINGS

The above and other objects and advantages of the present invention will become more fully apparent from the following detailed description taken with the accompanying drawings, in which:

FIG. 1 is an appearance perspective view showing a soup supplying apparatus according to a first embodiment of the invention;

FIG. 2 is a front sectional view showing the internal structure of the soup supplying apparatus according to the first embodiment;

FIG. 3 is a side sectional view showing the internal structure of the soup supplying apparatus according to the first embodiment;

FIG. 4 is a perspective view of the a soup supplying apparatus according to the first embodiment of the invention when the upper cover covering the opening of the upper portion of an apparatus body has been rotated upward to open;

FIG. 5 is a perspective view of the configuration of the linkage mechanism and vessel in the soup supplying apparatus according to the first embodiment;

FIG. 6 is a front view of the ladle used in the soup supplying apparatus according to the first embodiment;

FIG. 7 is a front sectional view of the ladle used in the soup supplying apparatus according to the first embodiment;

FIG. 8 is a plan view of the ladle used in the soup supplying apparatus according to the first embodiment;

FIGS. 9A-9C are side sectional views showing in order the operating states of the linkage mechanism and the hopper within the vessel when the soup accommodated in the vessel is sub-divided into an eating utensil in a soup supplying apparatus according to an embodiment of the invention, wherein FIG. 9A shows the state when the linkage mechanism in the vessel has rotatively moved from a stand-by state to a predetermined position in the direction opposite to the opening 11a of the ladle 11, FIG. 9B shows the state when the linkage mechanism in the vessel rotatively moves in the opening 11a direction of the ladle 11 so that the ladle is inserted into the wide mouth of the hopper, and FIG. 9C shows the state when the ladle inserted in the hopper rotatively moves over the opening of the vessel to the outside thereof so that the soup in the ladle is poured into an eating utensil from a cylindrical mouth of the hopper;

FIG. 10 is a block diagram showing an exemplary configuration of the control for the soup supplying apparatus according to the first embodiment;

FIG. 11 is a table showing an example of reciprocative sliding table data stored in a ROM in the soup supplying apparatus according to the first embodiment;

FIG. 12 is a table showing an example of end sliding table data stored in a ROM in the soup supplying apparatus according to the first embodiment;

FIG. 13 is a flowchart showing an example of the processing flow in the controller in the reciprocative sliding mode;

FIG. 14 is a schematic view for explaining the movement of the ladle;

FIG. 15 is a flowchart showing an example of the processing flow in the controller in the end sliding mode;

FIG. 16 is a block diagram showing an exemplary configuration of the control for the soup supplying apparatus according to a second embodiment of the invention;

FIG. 17A is a table showing an example of sliding table data stored in a ROM in the soup supplying apparatus according to the second embodiment;

FIG. 17B is a table showing an example of pouring table data stored in a ROM in the soup supplying apparatus according to the second embodiment;

FIG. 18 is a schematic view for explaining the movement of the ladle;

FIG. 19 is a flowchart showing an example of the processing flow in the controller in a forward moving mode;

FIG. 20 is a flowchart showing an example of the processing flow in the controller in a backward moving mode;

FIG. 21 is a flowchart showing an example of the processing flow in the controller in a ladling mode;

FIG. 22 is a flowchart showing an example of the processing flow in the controller in a pouring mode; and

FIG. 23 is a block diagram showing another exemplary configuration of the control for the soup supplying apparatus according to the second embodiment.

### DETAILED DESCRIPTION OF THE PREFERRED EMBODIMENTS

Referring now to the accompanying drawings, a description will be given in detail of preferred embodiments of the invention.

### First Embodiment

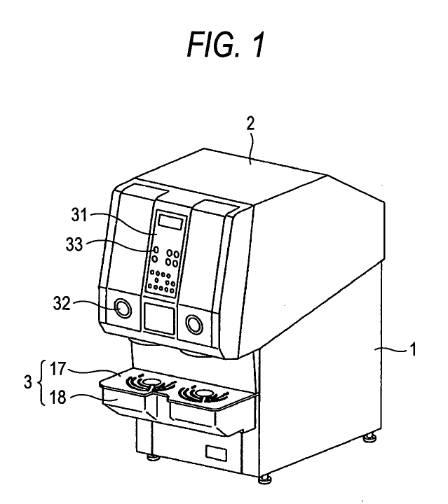

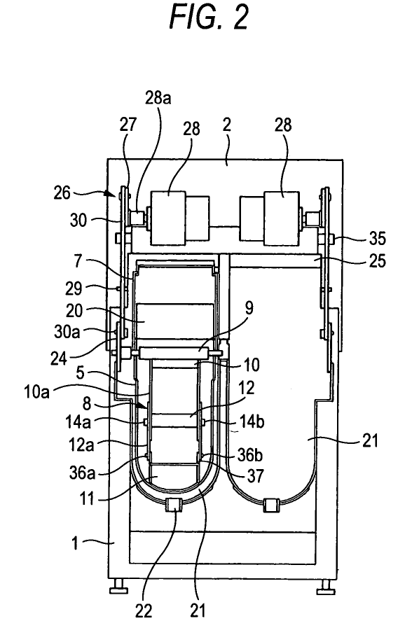

A soup supplying apparatus according to a first embodiment, as shown in FIGS. 1-5, includes an apparatus body 1 for holding a vessel 5 accommodating a soup, an upper cap 2 covering the upper part of the body 1 to open and close the upper part of the body 1, and eating utensil placing portions 3 each located in front of the body 1 where an eating utensil 16 into which the soup is sub-divided is placed.

The apparatus body 1 includes two vessel holding portions 21 each for holding a vessel 5 accommodating the soup. The vessel holding portion 5 is, on its bottom, provided with a heating device 22 for heating and keeping warm the soup accommodated in the vessel 5. The vessel holding portions 21 each is provided, on the front thereof, is provided with a recess 21a where the vessel is attached or detached. The apparatus body 1 is provided with a detachable front cover 23 covering the recesses 21a. Incidentally, it is assumed that the vessel according to the embodiment is metallic.

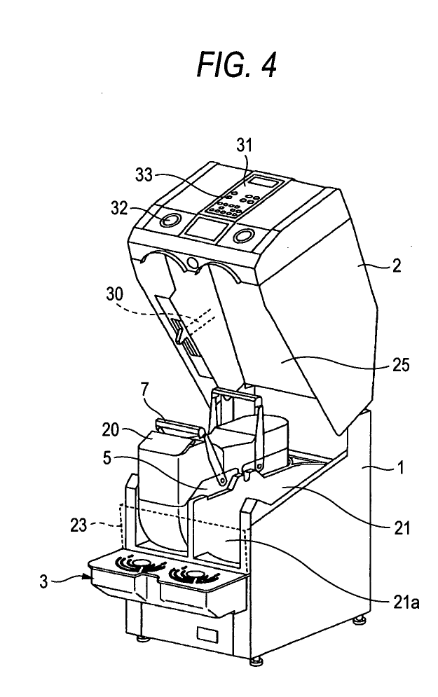

The upper cap 2 includes a cover 25 for covering the upper portion of the vessel 5 held in the vessel holding portion 21; a driving device 26 arranged on the cover 25, which includes a driving motor 28 for driving a ladle 11 for ladling the soup in the vessel 5; and a control panel 31 arranged to orient forward in front of the driving device 26 and provided with sub-division switches 32 each for starting the sub-division operation of the soup and setting buttons 33 for setting a soup warm-keeping temperature and others. The upper cap 2 is rotatably vertically linked with the apparatus body 1 by a supporting shaft 35 located at the rear. By rotating upward the upper cap 2 to open the upper part of the apparatus body 1 and detaching the front cover 23 (see FIG. 4), the vessel 5 accommodating the soup can be easily attached to or detached from the vessel holding portion 21 from the front of the apparatus body 1.

The eating utensil placing portion 3 has a placing stand 17 on which the eating utensil 16 is placed, and a soup recovering bucket 18 which serves to recover and accumulate the soup spilled when the soup is sub-divided into the eating utensil 16. The eating utensil placing portion 3 is detachably locked to the front of the apparatus body 1 by a hook 19.

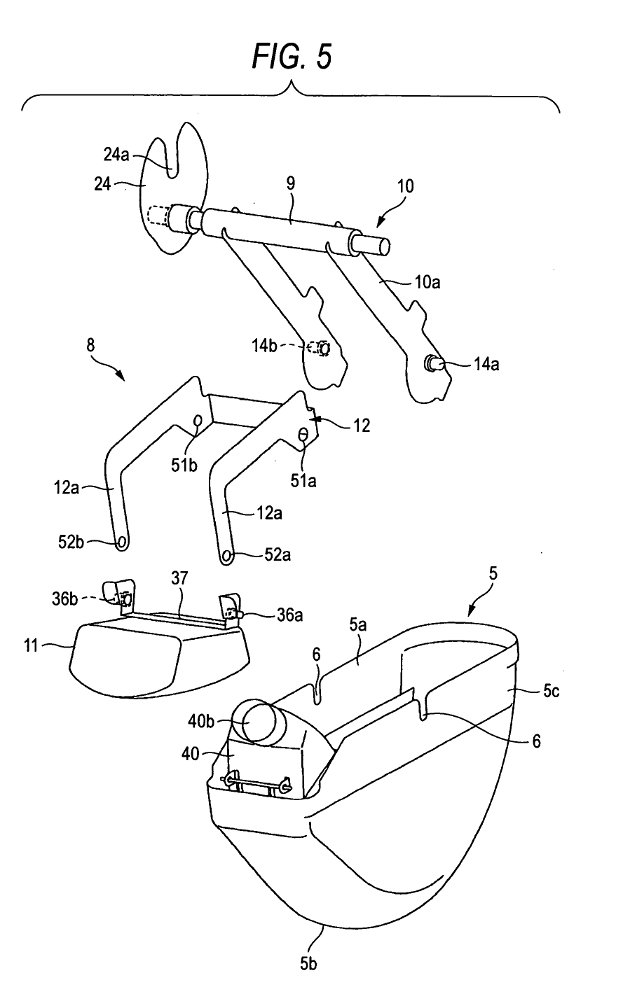

The vessel 5 accommodating the soup is formed in a semi-circular shape when viewed from the side. A bottom 5b is formed along the arc portion and an opening 5a is formed at the chord (see FIG. 5). A hopper 40 that rotatively moves outwardly through the opening 5a is journaled on the inside of the upper end of the bottom 5b. The bottom 5b is formed as a semi-circular curve with side portions 5c formed on both left and right sides thereof. The side portions 5c are provided with U-shaped grooves 6 for detachably supporting the linkage mechanism (ladling mechanism) 8 and gripping portions 7 for carrying the vessel 5. The vessel 5 is, on the upper portion, provided with a vessel cover 20 for covering the opening 5a.

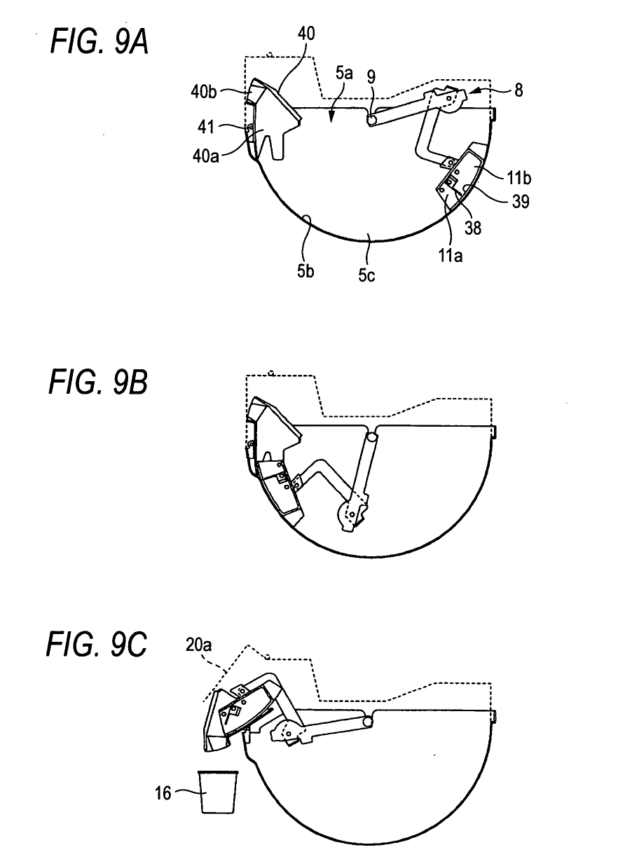

A hopper 40 is rotatably supported or journaled on the vessel 5 by a supporting shaft 41. The hopper 40 includes a wide mouth 40a (described later) into which the ladle 11 is inserted and a cylindrical mouth 40b from which the soup ladled by the ladle 11 is poured into the eating utensil 16 (FIGS. 9A-9C).

The linkage mechanism 8 arranged in the vessel 5 includes a rotary shaft 9, a rotary arm member 10 including a pair of square pieces 10a provided perpendicular to the rotary shaft 9, a U-shaped swing arm member 12 that is journaled to the tip of the rotary arm member 10, and a ladle 11 which is rotatably supported or journaled to the open end of the swing arm member 12.

At the tip of the pair of square pieces 10a which are provided on the rotary shaft 9 to constitute a rotary arm member 10, locking pins 14a, 14b are protruded outwardly for journaling the swing arm member 12. The swing arm member 12, in the vicinity of the base of a pair of tongue pieces 12 bent in parallel, is provided with opposite pin holes 51a, 51b in which the locking pins 14a, 14b are to be fit, respectively. At the tip of the swing arm member 12, coupling holes 52a, 52b are formed for the coupling the ladle 11 with the swing arm member 12. On the ladle 11, a coupling plate 37 is placed which is provided with protrusive coupling pins 36a, 36b that are be fit in the coupling holes 52a, 52b of the swing arm member 12. The linkage mechanism 8 can be easily dismantled by decoupling the respective components thereof from one another.

The linkage mechanism 8 is supported, in both ends thereof the rotary shaft 9, rotatably and removably by the U-shaped grooves 6 formed on both sides 5c of the vessel 5, and hence can be freely rotatively moved in the vessel.

At the one end of the rotary shaft 9, a plate-like coupling plate 24 is provided which is coupled with the driving device 26 arranged on the upper cap 2 to rotate the linkage mechanism 8 back and forth. The coupling plate 24 has a groove 24a to be engaged with a driving coupling pin 30a of the driving device 26 described later.

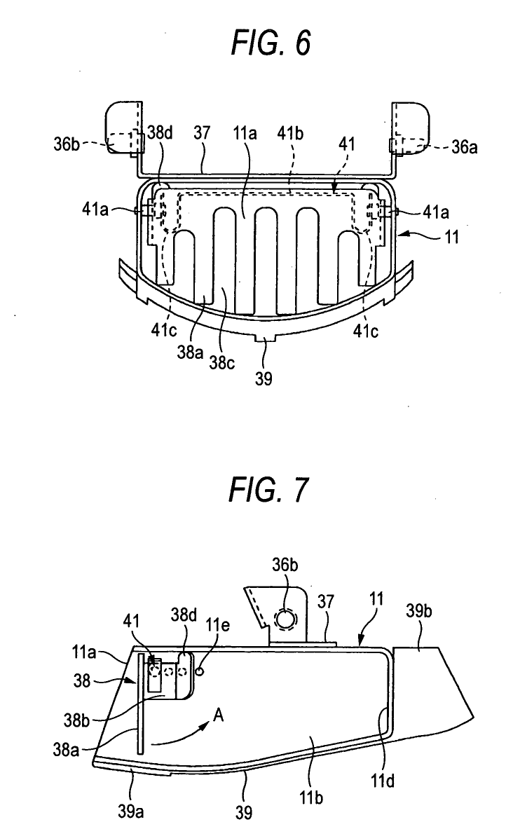

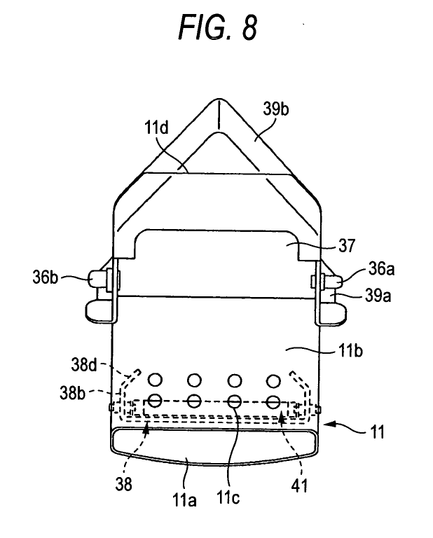

As shown in FIGS. 6-8, the ladle 11 is formed in a sack shape with an opening 11a at the one end. The ladle 11 has an soup accommodating section 11b for ladling the soup in the inside thereof.

The ladle 11, on upper part thereof, is provided with an air vent(s) 11c for removing the internal air when the soup is accommodated in the soup accommodating portion 11b. The soup accommodating section 11b has a partitioning net 38 which partitions itself into an opening 11a side and an inner side or backside. Further, the ladle 11 is, on the bottom, provided with a scraper 39 in contact with the bottom 5b of the vessel 5.

The scraper 39 is designed so that its bottom 39a follows the bottom 5b of the vessel 5. When the linkage mechanism 8 rotatively moves within the vessel 5, the scraper 39 slides over the bottom 5b while its bottom is in wide contact with the bottom 5b of the vessel 5. The rear 39b of the scraper 39 is formed to cover the rear lid of the ladle 11 to protrude rearward in a wedge shape. Therefore, when the ladle 11 rotatively moves rearward in the direction opposite to the opening 11a, it can rotatively move with less resistance to the soup within the vessel 5. In the case, since the ladle 11 rotatively moves while stirring the ingredients mixed in the soup within the vessel 5, it does not scoop up the ingredients onto the outer fence at the upper part or rear part of the ladle 11

The partitioning plate 38 includes a planar partitioning plane section 38a which partitions the soup accommodating section 11b into an opening 11a side and an inner or back side, and bending sections 38b formed by bending both sides of the partitioning plane section 38a toward the inner side. The partitioning plane section 38a has slits 38c which do not pass the ingredients having a predetermined shape contained in the soup and passes only the soup liquid. The bending sections 38b are rotatably journaled on both sides of the ladle 11 by a supporting shaft 41, respectively. On the inner side of the upper end of the bending section 38b, a stopper section 38d is formed to control the rotative movement of the partitioning plate 38 from the partitioning position to the inner side. The portioning plate 38 configured in the manner is rotatively movable freely toward the opening 11a side around the supporting shaft 45. Further, since the position of center of gravity of the portioning plate 38 thus formed is located at the position close to the opening 11a side with respect to the supporting shaft 41, the partitioning plate 38, while being rotatively urged to the depth side of the soup accommodating section 11b as indicated by arrow A shown in FIG. 7, is kept at the partitioning position where the soup accommodating portion 11b is partitioned into the opening 11a side and the inner side.

The supporting shaft 41 includes shaft segments 41a provided at both ends to suspend the partitioning plate 38 and a coupling plate 41b with warping portions 41c formed on both sides. By increasing/decreasing the length of the supporting shaft 41, the partitioning plate 38 can be easily attached to or detached from the ladle 11.

The ladle 11 having such a partitioning plate 38 is journaled on the tip of the linkage mechanism 8 so that it is rotatively movable with its opening 11a oriented toward the hopper 40 provided in the vessel 5. When the ladle 11 rotatively moves toward the hopper 40 in the vessel 5, it ladles up the soup with a predetermined ratio between the ingredients and soup liquid in the soup so that the ingredients mixed in the soup are accommodated in the opening 11a side of the soup accommodating portion 11b with respect to the partitioning plane section 38a whereas the soup liquid is accommodated in the inner side thereof. The ladle 11 has a plurality of partitioning plate fitting portions 11e in which the partitioning plate 38 is fit so that the partitioning position of the partitioning plate 38 can be changed. Therefore, by changing the partitioning position of the partitioning plate 38 as required, the ratio between the ingredients and soup liquid in the soup accommodated in the soup accommodating portion 11b can be changed. Further, a spacer not shown may be detachably provided in the soup accommodating portion 11b so that the contents therein are adjustable, thereby permitting the quantity of the soup to be ladled up by the ladle 11 to be changed.

The driving device 26 provided in the upper cap 2 includes a driving motor 28, an driving arm 27 secured to the rotary shaft 28a of the driving motor 28, a driving linkage piece 30 with one end journaled on the tip of the driving arm 27, a guiding shaft 29 engaged in a long slot 30b provided longitudinally along the driving linkage piece 30 and a driving coupling pin 30a engaged in a groove 24a formed on the coupling plate 24 of the linkage mechanism 8 provided at the other end of the driving linkage piece 30. In the driving device 26 thus configured, when the driving motor 28 is energized, the driving arm 27 rotates with the rotary shaft 28a so that the driving linkage piece 30 journaled on the tip of the driving arm 27 swings while being guided by the guiding shaft 29 engaged in the long slot 30b. Further, by the driving coupling pin 30a provided at the other end of the driving linkage piece 30, the coupling plate 24 of the linkage mechanism 8, engaged therewith is rotatively moved around the rotary shaft 9 so that the linkage mechanism 8 is rotatively moved. In the way, the linkage mechanism 8 is rotatively moved by the rotation of the driving motor 28.

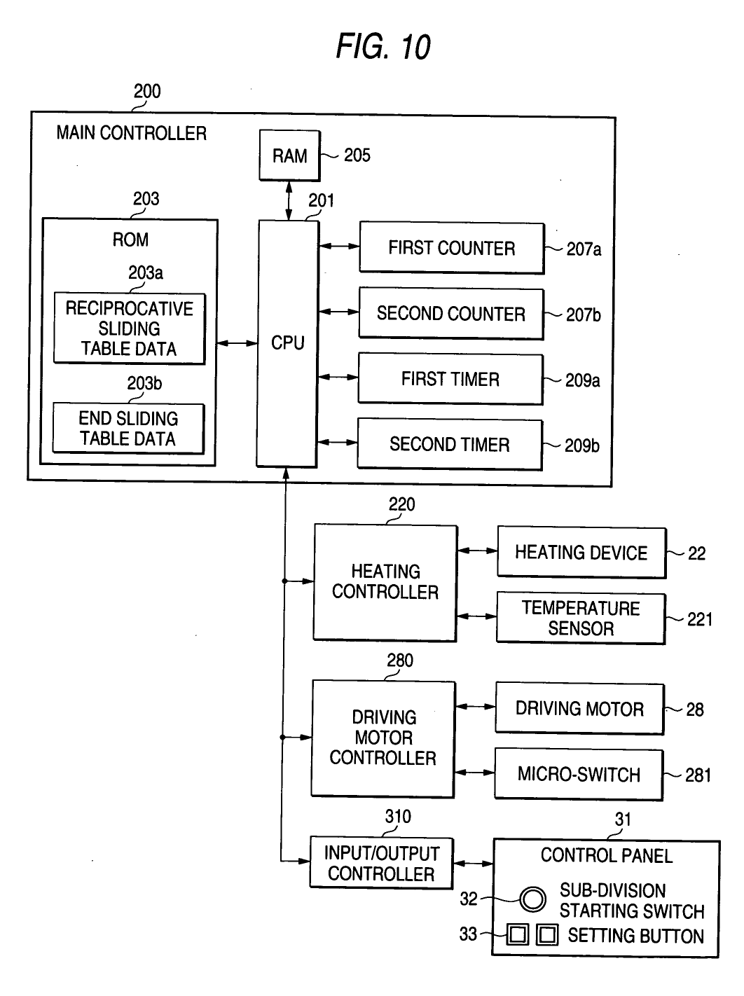

As illustrated in a block diagram shown in FIG. 10, the soup supplying apparatus according to the embodiment includes a warming controller 220, a driving motor controller 280, an input/output controller 310, etc. as well as a main controller 200 which controls the operation of the driving motor 28 and heating device 22 described previously.

The main controller 200 serves to make unified control of the soup supplying apparatus. As required, the main controller 200 includes a ROM 203, a RAM 205, counters 207 (first counter 207a, second counter 207b), timers 209 (first timer 209a, second timer 209b) in addition to a CPU 201. Incidentally, in the embodiment, not only the main controller 200 but also the warming controller 220, driving motor controller and input/output controller 310, etc. incorporate CPUs, respectively. However, without being limited to such a configuration, for example, the CPU 201 of the main controller 200 may be a single CPU which also serves as the CPUs for the respective sections described above, thereby directly controlling a warming device 22, a temperature sensor 221, a driving motor 28, a micro-switch 281, and a control panel 31.

The CPU 201 controls the driving motor controller 280 on the basis of e.g. a suitable program stored in ROM 203, thereby rotating, at predetermined time intervals, the driving motor 28, which is a DC motor equipped with a suitable pulse encoder, at a predetermined rotary speed in a predetermined direction by a predetermined number of pulses. Incidentally, it should be noted that in the following description, all the expressions of “the number of pulses” or “number of pulses in a driving motor 28” refer to the number of pulses produced by the pulse encoder. As described later, the predetermined time is measured by the first timer 209a and the predetermined number of pulses is counted by the first counter 207a. The driving motor controller 280, when it receives data of e.g. a polarity and current value, rotates the driving motor 28 in the rotary direction corresponding to the polarity at the rotary speed corresponding to the current value. Additionally, the micro-switch 281 illustrated in FIG. 10 is attached to the rotary shaft 28a of the driving motor 28 as required so that it turns on when the ladle 11 sits on the lowermost position in a vertical direction on the arc-shaped vessel 5 to generate a starting signal of measuring the number of pulses in the driving motor 28.

Further, the CPU 201 controls the warming controller 220 on the basis of e.g. a suitable program stored in ROM 203 to cause the warming device 22 to heat the vessel 5 and simultaneously detect the temperature of the soup by a temperature sensor 221 as required around the vessel 5. The detection of the temperature of the soup is based on the data detected by the temperature sensor 221.

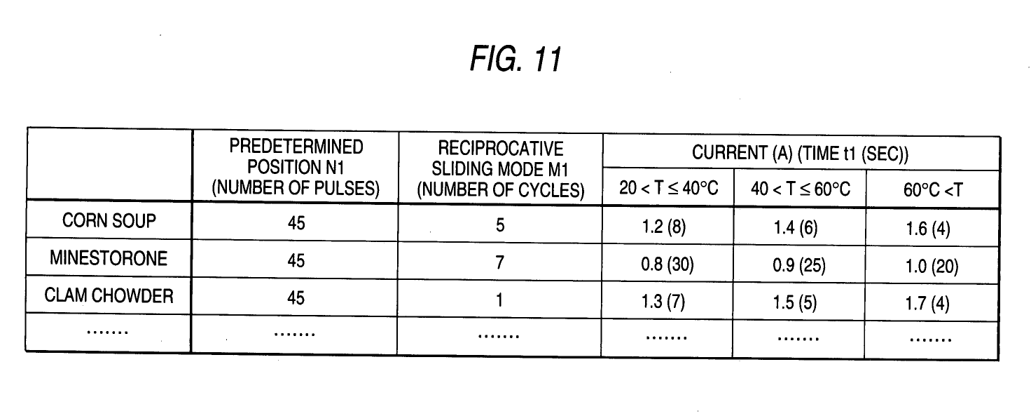

The ROM 203 serves to store table data 203a for reciprocative sliding (hereinafter referred to as reciprocative sliding table data 203a) (see FIG. 11) in which current value data and time data during one cycle in a reciprocative sliding mode are correlated for each kind of the soup as the reciprocative sliding mode (mode of not pouring the soup). The current value data is transmitted to the driving motor controller 280 by the CPU 201 for the temperature of the soup detected by the temperature sensor 221. The time during the one cycle operation is measured by the second timer 209b.

The reciprocative sliding table data 203a also includes the number of pulses in the driving motor 28 which corresponds to the amplitude (predetermined position) of the reciprocative sliding of the ladle 11 around the base point of the lowermost position in the above vertical direction, correlated according to the kind of the soup. For example, the number of pulses shown in FIG. 11 is that when one pulse is given to angle of one degree from the base point of the lowermost position in the vertical direction. Therefore, for example, the number of 45 pulses corresponds to the position at the angle of 45 degrees from the base point.

The reciprocative sliding table data 203a also includes the data corresponding to the frequency of the operation of sliding the ladle 11 (end sliding mode in the mode not pouring the soup) toward the inner side of the vessel 5 from the lowermost position in the above vertical direction with an amplitude larger than that (predetermined position) of the reciprocative sliding according to the kind of the soup. For example, in the reciprocative sliding mode, after the ladle 11 slides to a predetermined position (number of pulses=N1) backward from the lowermost position in the vertical direction, it returns to the lowermost position. Next, after the ladle 11 slides to a predetermined position (number of pulses=N1) forward from the lowermost position in the vertical direction, it returns to the lowermost position. This operation refers to one cycle of the reciprocative sliding. On the other hand, in the end sliding mode, after the ladle 11 slides to a predetermined higher position (number of pulses=N2>N1) backward from the lowermost position in the vertical direction, it returns to the lowermost position. Next, after the ladle 11 slides to the above predetermined position (number of pulses=N1) forward from the lowermost position in the vertical direction, it returns to the lowermost position. This operation refers to one cycle of the end sliding. The frequency of the end sliding mode in the embodiment refers to the number of cycles of the operation in the reciprocative sliding mode executed before and after the one cycle of the operation in the end sliding mode is executed. For example, the frequency of “5” refers to execution of the one cycle of the end sliding for every 5 (five) cycles of the reciprocative sliding, and the frequency of “7” refers to execution of the one cycle of the end sliding for every 7 (seven) cycles of the reciprocative sliding. The frequency of “1” refers to alternate execution of the reciprocative sliding and the end sliding. Incidentally, the number of cycles is counted by the second counter 207b.

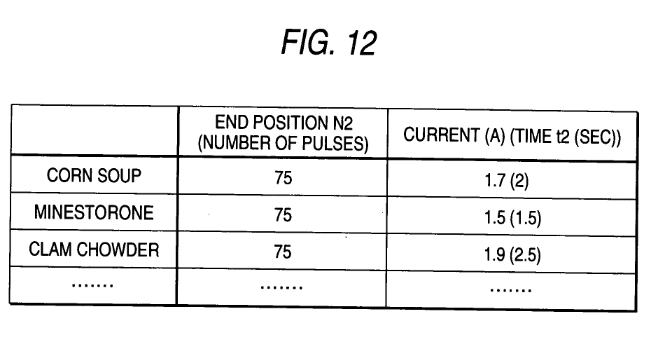

Further, the ROM 203 serves to store table data 203b for end sliding (hereinafter referred to as end sliding table data 203b)(see FIG. 12) in which current value data and time data are correlated with each other in the above end sliding mode according to the kind of the soup. The current value data is transmitted to the driving motor controller 280 by the CPU 201 when the ladle 11 slides to a predetermined higher position (number of pulses=N2>N1) backward from the lowermost position in the vertical direction. The time data represents the time during which the current value is once made zero at the end position. The time is measured by the second timer 209b.

The end sliding table data 203b includes the above number of pulses N2 correlated according to the kind of the soup. The number of pulses shown in FIG. 12 is also that when one pulse is given to angle of one degree from the base point of the lowermost position in the vertical direction. Therefore, for example, the number of 75 pulses corresponds to the position at the angle of 75° from the base point.

Incidentally, the above various parameters in the reciprocative sliding table data 203a (FIG. 11) and end sliding table data 203b (FIG. 12) can be set from the setting buttons 33 located on the control panel 31.

The aforesaid program is made as required in such a manner that the CPU 201, when it receives an “on” signal through the input/output controller 310 from the sub-division starting switch 32 located on the control panel 31, changes the operation mode from the reciprocative sliding mode or end sliding mode (mode of not porting the soup) to a sub-division mode (mode of pouring the soup) to control the driving motor controller 280.

Further, the RAM 205 serves to store data of the kind of the soup set by suitably operating the setting buttons 33 and data of the temperature of the soup timely measured by the temperature sensor 221.

In the soup supplying apparatus configured as described hitherto, an explanation will be given of the operation of stirring the soup accommodated in the vessel 5, the operation which is referred to as a reciprocative sliding mode.

First, it is assumed that the following preparations are made. On the basis of the quantity of the ingredients contained in the soup, the ratio between the ingredients and the soup liquid of the soup to be ladled up by the ladle 11 is determined. According to the ratio thus determined, the partitioning plate 38 is fit in one of the partitioning plate fitting portions 11c at the plurality of positions of the ladle 11. Next, the linkage mechanism 8 with the ladle 11 mounted is put in the vessel 5 so that the rotary shaft 9 of the linkage mechanism 8 is attached to the U-shaped grooves 6 provided on the sides 5c of the vessel 5. Subsequently, the soup is poured into the vessel 5 and accommodated therein. Incidentally, the ladle 11 is previously arranged at the lowermost position in the vertical direction in the arc-shaped vessel 5.

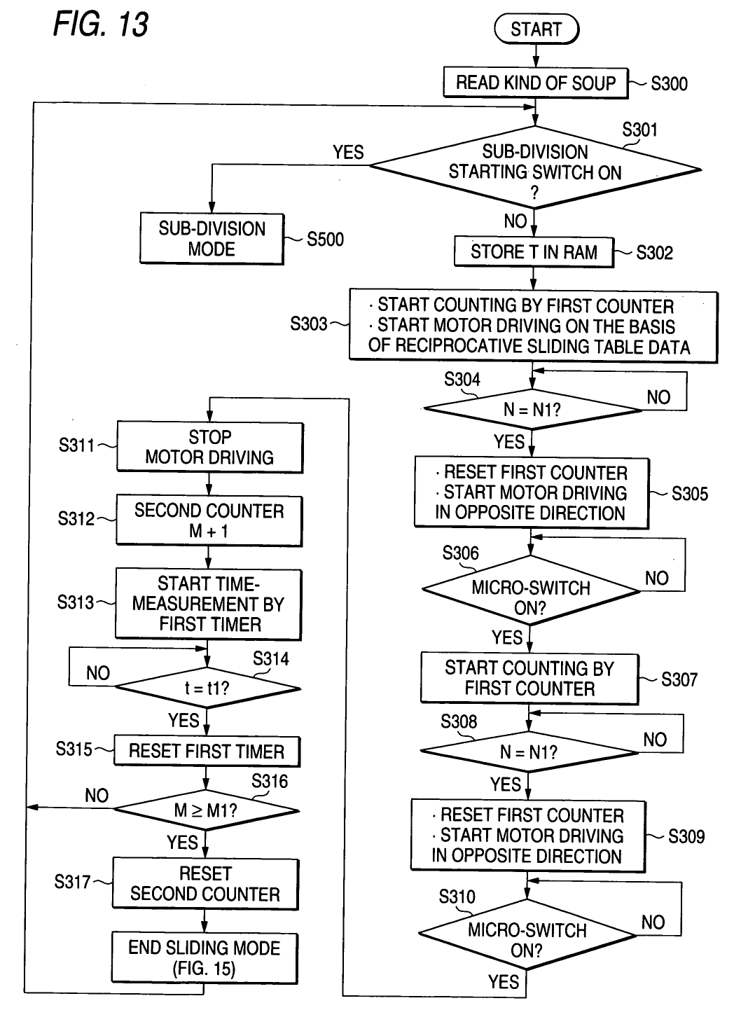

As seen from the flowchart of FIG. 13, the CPU 201 reads out the data of the kind of the soup stored in the RAM 205 (S300). The kind of the soup is previously set by the suitable operation of the setting button 33 located on the control panel 31. The data is stored in the RAM 205.

Next, the CPU 201 determines the ON/OFF state of the sub-division switch 32 located on the control panel (S301). If it is determined that the sub-division switch 32 is ON (S301: YES), the CPU 201 executes the sub-division mode operation described later (S500).

If it is determined that the sub-division switch 32 is OFF, the CPU 201 causes the RAM 205 to store the data of the temperature detected at a predetermined sampling period by the temperature sensor 221 (S302). Incidentally, the CPU 201 determines whether or not the temperature T detected is higher than a predetermined temperature (e.g. 20° C.), and if T<20° C., as the case may be, does not the following processing. Namely, if the temperature of the soup is not higher than 20° C., the soup is not stirred. Therefore, for example, if the soup that is so hard at a low temperature that it is difficult to stir the soup, the soup may not be stirred compulsorily. Further, the soup that is at so low a temperature as to provide no fear of burning/sticking may not stirred unnecessarily. This saves power consumption and gives no fear of crushing the ingredients by excessive stirring.

Next, the CPU 201 causes the first counter 207a to start to count. The CPU 201 also acquires the current value, on the reciprocative sliding table data 203a stored in the ROM 203, correlated with the kind and temperature (T) of the soup read out from the RAM 205 and causes the driving motor controller 280 to supply the current corresponding to the above current value in a predetermined polarity to the driving motor 28 (S303). This polarity is the polarity of rotating the driving motor 28 so that the ladle 11 slides backward of the vessel 5 from position A to position B (FIG. 14).

Next, referring to the count value in the first counter 207a, the CPU 201 determines whether or not the number of pulses (N) of the driving motor 28 counted by the first counter 207a has reached the number of pulses (N1) correlated with the soup on the reciprocative sliding data 203a stored in the ROM 203 (S304).

If it is determined that N is equal to N1 (S304: YES), the CPU 201 resets the first counter 207, and also causes the driving motor controller 280 to supply the current having the same value as in step S303 at an opposite polarity to that in step S303 to the driving motor 28 (S305). Thus, the ladle 11 returns from the predetermined position (position B in FIG. 14) on the inner side in the vessel 5 to slide toward the lowermost position in the vertical direction from position B to position A (FIG. 14).

When the ladle 11 reaches the lowermost position (position A in FIG. 14) in the vertical direction in the vessel 5, the micro-switch 281 is depressed. The CPU 201, when it receives the ON of the micro-switch 281 (S306: YES), causes the first counter 207a to start the counting of the number of pulses of the driving motor 28 again (S307).

Next, referring to the count value in the first counter 207a, the CPU 201 determines again whether or not N has reached N1 (S308). If N equals to N1 (S308: YES), the CPU 201 resets the first counter 207a and operates the driving motor 28 with the current having the same value as in step S305 at an opposite polarity to that in step S305 (S309). Thus, the ladle 11 returns from the predetermined position (position C in FIG. 14) on the front side in the vessel 5 to slide toward the lowermost position in the vertical direction from position C to position A (FIG. 14).

When the ladle 11 reaches the lowermost position (position A in FIG. 14) in the vertical direction in the vessel 5, the micro-switch 281 is depressed. The CPU 201, when it receives the ON of the micro-switch 281 (S310: YES), causes the driving motor controller 280 to stop the operation of the driving motor (S311).

The CPU 201 increments the second counter 207b by 1 (one) (S312).

Further, the CPU 201 causes the first timer 209a to start time measurement (S313), and determines whether or not the time (t) measured by the first timer 209a has reached the time (t1) during one cycle operation correlated with the kind and temperature (T) of the soup on the reciprocative sliding table data 203a stored in the ROM 203 (S314: YES). If it is determined that t is equal to t1 (S314: YES), the CPU 201 resets the first timer 209a.

Further, referring to the count value in the second counter 207b, the CPU 201 determines whether or not the number of cycles of the operation in the reciprocative sliding mode (S303 to S311) counted by the second counter 20b has reached the number of cycles (M1) correlated with the kind of the soup on the reciprocative sliding table data 203a stored in the ROM 203 (S316).

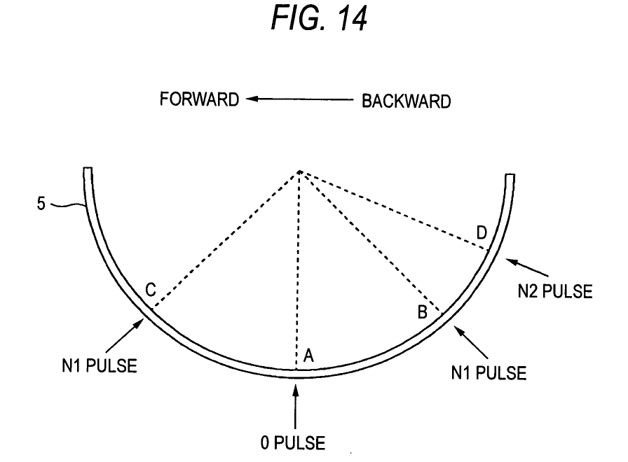

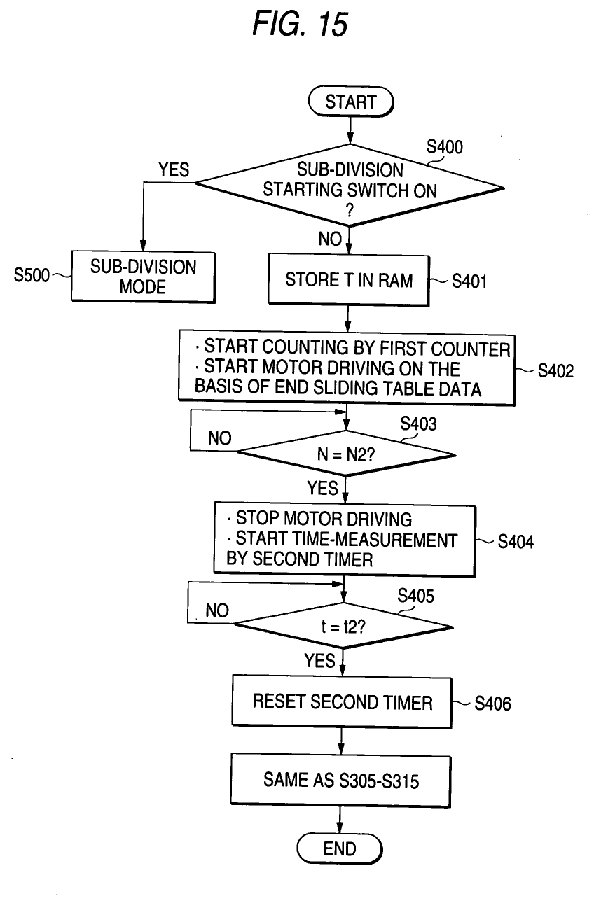

If it is determined that M is not smaller than M1 (S316: YES), the CPU 201 resets the second counter 207b (S317). The CPU 201 thereafter executes the end sliding mode operation (see FIG. 15) and repeats the operation in step S301.

If it is determined that M is smaller than M1, the CPU 201 repeats the operation in step S301.

Hereinafter, another operation of stirring the soup accommodated in the vessel 5, the operation which is referred to as an end sliding mode.

As shown in FIG. 15, the CPU 201 determines the ON/OFF state of the sub-division switch 32 located on the control panel (S400). If it is determined that the sub-division switch 32 is ON (S400: YES), the CPU 201 executes the sub-division mode operation (S500).

If it is determined that the sub-division switch 32 is OFF (S400: NO), the CPU 201 causes the RAM 205 to store the data of the temperature detected at a predetermined sampling period by the temperature sensor 221 (S401). Incidentally, the CPU 201 determines whether or not the temperature T detected is higher than a predetermined temperature (e.g. 20° C.) and if T<20° C., as the case may be, does not the following processing. Namely, if the temperature of the soup is not higher than 20° C., the soup is not stirred. Therefore, for example, if the soup has a certain level of thickness at a low temperature that it is difficult to stir the soup, the soup may not be stirred compulsorily. Also, in a case where the soup has a characteristic that no burning or sticking is anticipated at a low temperature, the soup may not stirred unnecessarily. This saves power consumption and gives no fear of crushing the ingredients by excessive stirring.

Next, the CPU 201 causes the first counter 207a to start to count. The CPU 201 also acquires the current value, on the end sliding table data 203a stored in the ROM 203, correlated with the kind and temperature (T) of the soup read out from the RAM 205, and causes the driving motor controller 280 to supply the current corresponding to the above current value in a predetermined polarity to the driving motor 28 (S402). This polarity is the polarity of rotating the driving motor 28 so that the ladle 11 slides backward of the vessel 5 (from position A to position D in FIG. 14).

Next, referring to the count value in the first counter 207a, the CPU 201 determines whether or not the number of pulses (N) of the driving motor 28 counted by the first counter 207a has reached the number of pulses (N2) correlated with the soup on the end sliding data 203b stored in the ROM 203 (S403).

If it is determined that N is equal to N1 (S403: YES), the CPU 201 resets the first counter 207. The CPU 201 also causes the driving motor controller 280 to stop the driving motor 28 and the second timer 209b to start time measurement (S404). Incidentally, as shown in FIG. 14, position D is located at a position higher than position B.

Next, the CPU 201 determines whether or not the time (t) measured by the second timer 209b has reached the time (t2) during which the current value is once made zero, correlated with the kind of the soup on the end sliding table data 203b stored in the ROM 203 (S405).

If it is determined that t is equal to t2 (S405: YES), the CPU 201 resets the second time 209b (S406), and executes the same operation as that in step S305 to S315 described above. Incidentally, in the embodiment, the driving motor 28 is locked by a suitable locking mechanism (not shown) so that the ladle 11 stops at position D during the process from step S403: YES to step S405: YES.

In the reciprocative sliding mode and the end sliding mode described above, the soup accommodated in the vessel 5 is stirred by the ladle 11 of the linkage mechanism 8. When the driving motor 28 of the driving device 26 provided in the upper cap 2 is energized, the link driving mechanism 8 and the ladle 11 at its tip are rotatively moved backwards in the direction opposite to the opening 11a through the driving linkage piece 30. When they are rotatively moved to e.g. the position inclined by 45 degrees backward (FIG. 9, position B in FIG. 14), the ladle 11 as well as the linkage mechanism 8 is now rotatively moved forward in an opposite direction (the opening 11a direction). Likewise, when they are rotatively moved to the position inclined by 45 degrees forward (position C in FIG. 14), the ladle 11 as well as the linkage mechanism 8 is rotatively moved backward as described above. After such an operation is repeated several numbers of times (M1), the ladle 11 is once rotatively moved backward further largely to the position inclined by e.g. 75 degrees so that the soup accumulated in the ladle 5 is poured out. This operation cycle is performed successively or intermittently. Thus, the soup accommodated in the vessel 5 is stirred by the ladle 11.

The position of center of gravity of the partitioning plate 38 is located at the position close to the opening 11a side with respect to the supporting shaft 41 so that the portioning plate 38 does not rotatively move in the opening 11a direction when the ladle 11 with the opening 11a oriented downward rotatively moves to the position inclined by 45 degrees backward as described above.

Namely, the partitioning plate 38, while being rotatively urged to the inner side of the soup accommodating section 11b, is kept at the partitioning position. This prevents the partitioning plate 38 on the way of the rotative movement of the ladle from opening or releasing so that the ingredients do not proceed into the inner side of the soup accommodating portion 11b.

The partitioning plate 38 with its upper part journaled on the supporting shaft 41 is configured rotatably toward the opening 11a. Therefore, when the soup ladled into the soup accommodating portion 11b is poured out from the opening 11a, the partitioning plate 38 rotatively moves toward the opening 11a. Thus, the partitioning of the soup accommodating portion 11b is easily released. Specifically, even where the soup accommodated in the vessel 5 mixedly contains fine ingredients/dregs or extracts passing the slits of the partitioning plate 38 and these ingredients/dregs proceed into the inner part of the soup accommodating portion 11b of the ladle 11, when the soup within the ladle 11 is poured out from the opening 11a, the ingredients/dregs or extracts as well as the soup liquid flow toward the opening 11a from the inner part of the ladle 11 and are poured out. Thus, by rotatively moving the ladle 11 to the largely inclined position (e.g. position inclined by 75 degrees backward) on the way of stirring so that the soup accumulated in the ladle 5 is poured, the ingredients/dregs or extracts do not accumulate within the ladle 11.

Specifically, where the ladle 11 is rotatively moved to stir the soup within the vessel 5 as described above, the volume of the inner part of the soup accommodating portion 11b of the ladle 11 is not reduced. For the reason, when the soup is ladled up, the ratio between the ingredients and the soup solution can be always kept constant.

In accordance with the soup supplying apparatus according to the embodiment, the driving motor 28 is controlled so that the speed when the ladle 11 reciprocatively slides between predetermined positions (position B and position C in FIG. 14) on the inner periphery of the vessel 5 is variable according to the kind of the soup.

For example, on the reciprocative sliding table data 203a (FIG. 11), for the soup with more thickness such as corn soup, the current to be supplied to the driving motor 28 is set at a large value.

For the soup with less thickness such as minestrone, the current to be supplied to the driving motor 28 is set at a small value. Thus, the corn soup, through which heat is difficult to travel, can keep its uniformity of temperature for each vending as in the case of the minestrone. Further, the corn soup with small ingredients can maintain the ratio between the ingredients and soup liquid constant for each vending as in the case of the minestrone with large ingredients. Accordingly, the soup, regardless of the kind thereof, can be easily sub-divided while keeping its quality.

In accordance with the soup supplying apparatus according to the embodiment, the driving motor 28 is controlled so that the speed when the ladle 11 reciprocatively slides between predetermined positions (position B and position C in FIG. 14) on the inner periphery of the vessel 5 is variable according to the temperature of the soup. For example, on the reciprocative sliding table data 203a (FIG. 11), for a relatively low temperature of the soup using milk as a material such as corn soup, the current to be supplied to the driving motor 28 is set at a relatively small value.

For a relatively high temperature thereof, the current to be supplied to the driving motor 28 is set at a relatively large value. In the way, the soup using milk as a material which is prone to burn and stick can be heated without being stirred unnecessarily and being prevented from burning/sticking. Since unnecessary stirring is not performed, the soup such as clam chowder which uses milk as a material and contains ingredients which are prone to break into pieces such as potato can be heated while being prevented from burning/sticking and breaking-into-pieces of the ingredients. Further, the manner of stirring can be changed according to whether the soup is heated or kept warm. Namely, in heating, the soup can be stirred swiftly, whereas in keeping warm, the soup can be stirred slowly. Accordingly, the soup can be easily sub-divided while keeping its quality.

Further, in accordance with the soup supplying apparatus according to the embodiment, as the temperature of the soup rises, the ladle 11 can be reciprocatively slid at a higher speed between predetermined positions (position B and position C in FIG. 14) on the inner periphery of the vessel 5. In the way, for example, the soup which is prone to burn/stick can be effectively heated without being stirred unnecessarily and being prevented from burning/sticking.

The soup which is so hard to be difficult to stir can be also stirred at a higher speed as the temperature rises.

In accordance with the soup supplying apparatus according to the embodiment, if the temperature of the soup is not higher than a predetermined temperature (e.g. 20° C.), the ladle 11 does not carry our the operation of reciprocative sliding described above (step S301: NO and S401). On the other hand, for the soup using the material prone to burn/stick, if the temperature is not so high to generate burning/sticking, the stirring is not required. Therefore, if the above predetermined temperature (20° C.) is set at a temperature at which the soup does not burn/stick without being stirred, the soup can be more effectively heated without being stirred unnecessarily and being prevented from burning/sticking.

In accordance with the soup supplying apparatus according to the embodiment, the driving motor 28 is controlled so that the speed when the frequency of reciprocative sliding of the ladle 11 between predetermined positions (position B and position C in FIG. 14) on the inner periphery of the vessel 5 is variable according to the temperature of the soup. For example, on the reciprocative sliding table data 203a (FIG. 11), for a relatively low temperature of the soup using milk as a material such as corn soup, t1 is set to be relatively long in order to make the frequency of the reciprocative sliding relatively low. For a relatively high temperature thereof, t1 is set to be relatively short in order to make the frequency of the reciprocative sliding relatively high.

In the way, the soup using milk as a material which is prone to burn and stick can be heated without being stirred unnecessarily and being prevented from burning/sticking. Accordingly, the soup can be easily sub-divided while keeping its quality.

In accordance with the soup supplying apparatus according to the embodiment, as the temperature of the soup rises, the ladle 11 can be reciprocatively slid at a higher frequency between predetermined positions (position B and position C in FIG. 14) on the inner periphery of the vessel 5. In the way, for example, the soup which is prone to burn/stick can be effectively heated without being stirred unnecessarily and being prevented from burning/sticking.

In accordance with the soup supplying apparatus according to the embodiment, the driving motor 28 is controlled in order to repeat the operation of reciprocative sliding of the ladle 11 between predetermined positions (position B and position C in FIG. 14) on the inner periphery of the vessel 5 and the operation of sliding of the ladle 11 toward the other end (position D in FIG. 14) on the inner periphery of the vessel 5 outside between the predetermined positions. In the way, by sliding the ladle 11 toward the position Din FIG. 14, for example, ingredients/dregs or extracts become more likely to fall and hence are difficult to accumulate within the ladle 11. This removes the fear of relatively reducing the quantity of the soup liquid within the ladle 111 owing to such ingredients/dregs or extracts. Thus, the quality of the soup sub-divided by the ladle 11 can be maintained. Since the above accumulation is difficult to occur, it is not necessary to clean the inside of the ladle 11. Accordingly, the soup can be easily sub-divided while keeping its quality.

In accordance with the soup supplying apparatus according to the embodiment, for example, on the end sliding table data 203b (FIG. 12), for the soup containing more ingredients/dregs or extracts, the current to be supplied to the driving motor 28 can be set to be relatively large. In the way, in step S402 described above, the ladle 11 slides at a higher speed between the positions A and B in FIG. 14 so that the ingredients/dregs or extracts are difficult to accumulate at the inner part of the ladle 11. For example, in FIG. 12, it is assumed that minestrone, corn soup and clam chowder are arranged in order of the soup containing more ingredients/dregs or extracts. In correspondence with the order, the current to be supplied to the driving motor 28 can be set to be larger.

In accordance with the soup supplying apparatus according to the embodiment, for example, on the reciprocative sliding table data 203a, for the soup containing more ingredients or extracts, the frequency (M1: 1) of the end sliding mode operation relative to the reciprocative sliding mode operation can be set to be relatively high. In the way, the operation of step S402 described above can be executed at a higher frequency so that the ingredients/dregs or extracts are difficult to accumulate at the inner part of the ladle 11. For example, in FIG. 11, it is assumed that minestrone, corn soup and clam chowder are arranged in order of the soup containing more ingredients/dregs or extracts. Namely, the end sliding is once executed for every 7 (seven) reciprocative slidings; the end sliding is executed for every 5 (five) reciprocative slidings, and the end sliding and reciprocative sliding are alternately executed.

In accordance with the soup supplying apparatus according to the embodiment, the ladle 11 temporarily stops at the position D in FIG. 14 so that the ingredients/dregs or extracts are difficult to accumulate at the inner part of the ladle 11.

In accordance with the soup supplying apparatus according to the embodiment, for example, on the end sliding table data 203b (FIG. 12), for the soup containing more ingredients or extracts, t2 can be set to be longer. In the way, in steps S404 to S407, the ladle 11 can be temporarily stopped for a longer time at the position D in FIG. 14 so that the ingredients/dregs or extracts are difficult to accumulate at the inner part of the ladle 11.

For example, in FIG. 12, it is assumed that minestrone, corn soup and clam chowder are arranged in order of the soup containing more ingredients/dregs or extracts. In correspondence with the order, the time t2 of temporary stopping is set to be longer.

Hereinafter, an explanation will be given of the function and operation of each component in sub-dividing the soup accommodated in the vessel 5 to an eating utensil 16 in the soup supplying apparatus having the configuration described hitherto. The operation described herein will be referred to as a sub-division mode (mode of pouring out the soup).

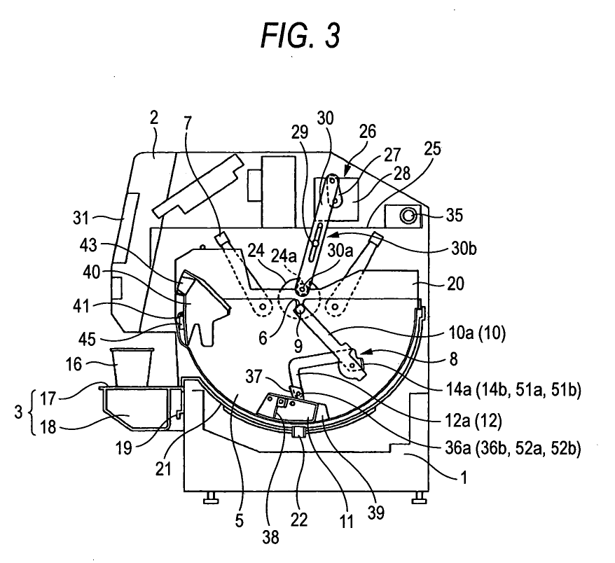

With the eating utensil 16 placed on the eating utensil placing portion 3, when a sub-division starting switch 32 on the control panel 31 is operated, the sub-division operation of the soup is started. Concretely, when the driving motor 28 of the driving apparatus 26 is energized, the linkage mechanism 8 is rotatively moved through the driving linkage piece 30 in the direction opposite to the opening 11a of the ladle 11 from a stand-by status as shown in FIG. 3. As shown in FIG. 9A, when the linkage mechanism 8 is rotatively moved to a predetermined position (e.g. position inclined by 45 degrees backwards), it starts to rotatively move in the opening 11a direction of the ladle 11. At the time, the ladle 11 makes the arc movement along the bottom 5b of the vessel 5 in sliding-contact therewith, thereby accommodating the soup into the soup accommodating portion 11b from the opening 11a. Here, the soup accommodated in the soup accommodating portion 11b is accumulated at a predetermined ratio between the ingredients and soup liquid by the partitioning plate 38.

Further, when the rotation further proceeds, as shown in FIG. 9B, the ladle 11 is inserted into the wide mouth 40a of the hopper 40 which is formed to lead to the arc-shaped bottom 5b of the vessel 5.

When the linkage mechanism 8 further rotatively moves, the ladle 11, while being inserted in the hopper 40 and integral thereto, around the supporting shaft 41 journaling the hopper 40, rotatively moves over the opening 5b of the vessel 5 to the outside thereof as shown in FIG. 9C. Thus, the soup within the ladle 11 is poured into the eating utensil 16 placed on the eating utensil placing portion 3. At the time, since the partitioning plate 38 within the ladle 11 rotatively moves toward the opening 11a to open owing to the pushing force by the pouring soup. As a result, all the ingredients/dregs as well as the soup liquid proceeded in the inner part of the soup accommodating portion 11b are discharged.

Further, in the case, the soup accommodated within the soup accommodating portion 11b of the ladle 11 is poured into the eating utensil 16 in a nearly constant state through the hopper 40 from its cylindrical mouth 40b. When the whole soup accommodated in the soup accommodating section 11b has been sub-divided into the eating utensil 16, the linkage mechanism 8 is rotated in an opposite direction so that the ladle 11 is returned into the vessel 5 again. Such an operation is repeated as required so that predetermined quantities of soup are sub-divided from the vessel 5 into the eating utensils 16.

Incidentally, the vessel cover 20 covering the opening 5a of the vessel 5 is normally closed. The vessel cover 20 is provided with a pouring mouth door 20a which is opened owing to pushing force resulting when the ladle 11, while being inserted in the hopper 40 and integral thereto, rotatively moves over the opening 5b of the vessel 5 to the outside thereof.

Meanwhile, the ladle 11 is provided with a partitioning plate 38 for passing the soup liquid without passing the ingredients mixed in the soup which is arranged to partition the internal soup accommodating portion 11b into an opening 11a side and an inner side.

Further, the partitioning plate 38 is released when the soup ladled in the soup accommodating portion 11b is poured out from the opening 11a. For the reason, even where the soup accommodated in the soup accommodating portion 11b mixedly contains fine ingredients/dregs or extracts passing the partitioning plate 38 and these ingredients/dregs proceed into the inner part of the soup accommodating portion 11b, when the soup within the soup accommodating portion 11b is poured out from the opening 11a, the ingredients/dregs or extracts as well as the soup liquid flow toward the opening 11a from the inner part of the ladle 11 and are poured out. Thus, these ingredients/dregs or extracts do not accumulate within the soup accumulating portion 11b so that the volume at the inner part of the soup accommodating portion is not reduced. Accordingly, the ingredients and soup liquid ladled up at a predetermined ratio can be sub-divided into the eating utensil.

Further, since the partitioning plate 38 with its one end journaled is rotatably configured, when the soup ladled into the soup accommodating portion 11b is poured out from the opening 11a, the partitioning plate 38 rotatatively moves toward the opening 11a so that partitioning within the soup accommodating portion 11b is easily released. Thus, the partition of the soup accommodating portion 11b can be configured at low cost.

Further, the partitioning plate 38 is journaled at its upper part with the position of center of gravity being close to the opening 11a and is provided with a stopper section 38d for preventing rotation toward the inner part. Thus, the partitioning plate 38, while being rotatively urged to the inner part of the soup accommodating section 11b, is kept at the partitioning position so that even when the opening 11a is inclined downward while the ladle 11 rotatively moves backward in the vessel, the partitioning plate 38 does not easily rotatively move toward the opening 11a. This prevents the partitioning plate 38 on the way of the rotative movement of the ladle from being released so that a large amount of ingredients proceed into the inner part of the soup accommodating portion 11b.

The ingredients and soup liquid always ladled up at a predetermined ratio therebetween can be sub-divided into the eating utensil.

The rear on the side opposite to the opening 11a of the ladle 11 is formed to protrude rearward in a wedge shape. Therefore, when the ladle 11 rotatively moves rearward, it does not stir the ingredients mixed in the soup within the vessel 5 to prevent the ingredients from being scooped up onto the outer fence of the ladle 11. Namely, since the quantity of the ingredients mixed in the soup within the vessel 5 is not reduced, when the ladle 11 rotatively moves toward the opening 11a to scoop up the soup, it can effectively scoop up the ingredients.

IIn accordance with the soup supplying apparatus according the embodiment, even where the soup accommodated in the apparatus mixedly contains fine ingredients/dregs passing the partitioning plate 38 as well as the ingredients that can be separated by the partitioning plate 38 of the ladle 11, it is possible to prevent the ingredients/dregs and extracts from accumulating within the ladle 11, thereby always scooping up the ingredients and soup liquid in a predetermined ratio therebetween to be sub-divided into the eating utensil when the soup within the vessel 5 is scooped up by the ladle 11.

Incidentally, it is needless to say that the invention should not be limited to the apparatus given by the embodiment and can be modified within a scope including the intention of the invention.

In the reciprocative sliding mode in the embodiment described above, one cycle is defined as a travel in which the ladle 11 moves from position A (FIG. 14) to position B (FIG. 14) in the vessel 5, returns at position B to pass position A and moves to position C (FIG. 14), and returns at position C to move to position A. However, such a definition is exemplary. For example, one cycle may be defined as a travel in which the ladle 11 moves from position C to position B, and returns at position B to move to position B.

Further, the reciprocative sliding mode and end sliding mode in the embodiment described above are not changed into the sub-division mode during one cycle. However, without being limited to the, another manner may be adopted.

The driving motor 28 in the embodiment described above is a DC motor equipped with a pulse encoder. However, the driving motor should not be limited to such a DC motor but may be a stepping motor.

It should be noted that the rotary speed of the stepping motor can be controlled by changing the frequency in exciting a plurality of exciting coils in order.

### Second Embodiment

Hereinafter, a soup supplying apparatus according to a second embodiment will be now described. Parts the same as those in the first embodiment are denoted by the same reference numerals as those in the first embodiment, so that detailed description of the parts will be omitted here.

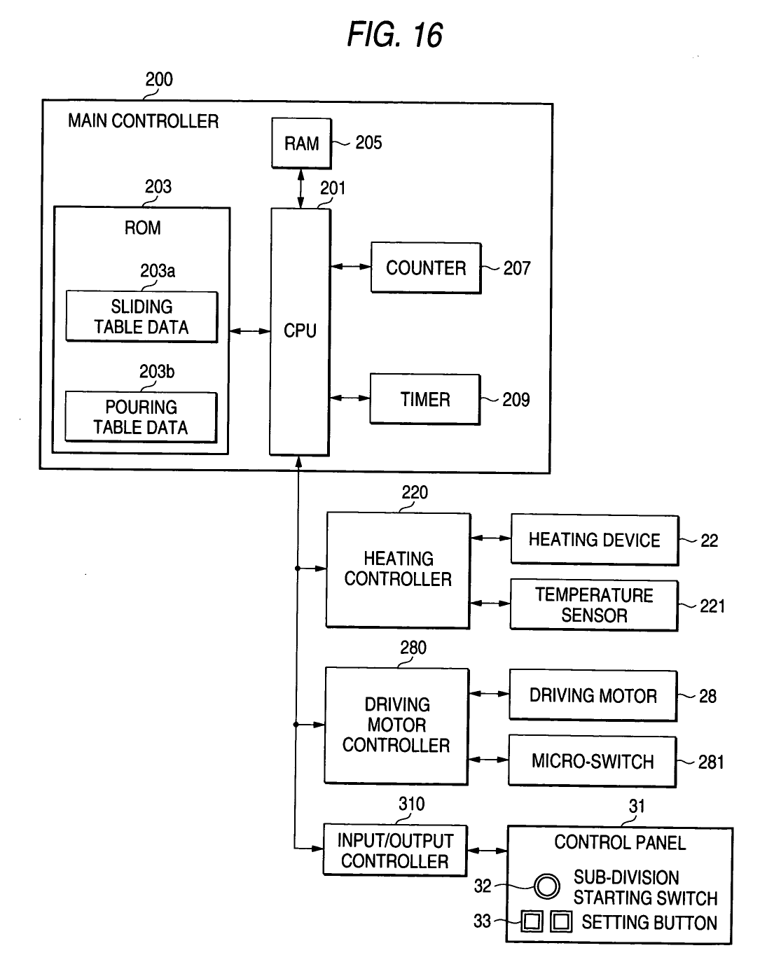

The soup supplying apparatus 1 according to the second embodiment includes a single counter 207 and a single timer 209 as shown in FIG. 16, instead of the first and the second counters 207a, 207b and the first and the second timers 209a, 209b.

The CPU 201 controls the driving motor controller 280 on the basis of e.g. a suitable program stored in ROM 203, thereby rotating the driving motor 28, which is a DC motor equipped with a suitable rotary encoder, at a predetermined rotary speed in a predetermined direction by a predetermined number of pulses. Incidentally, it should be noted that in the following description, all the expressions of “the number of pulses” or “number of pulses in a driving motor 28” refer to the number of pulses produced by the rotary encoder. As described later, the predetermined number of pulses is counted by the counter 207. The driving motor controller 280, when it receives data of e.g. a polarity and current value from the CPU 201, rotates the driving motor 28 in the rotary direction corresponding to the polarity at the rotary speed corresponding to the current value. In the embodiment, that the current value is large and hence the rotary speed of the driving motor is high correspond to that the driving force is large.

Further, the CPU 201 controls the warming controller 220 on the basis of e.g. a suitable program stored in ROM 203 to cause the warming device 22 to heat the vessel 5 and simultaneously detect the temperature of the soup by a temperature sensor 221 provided as required around the vessel 5. The detection of the temperature of the soup is based on the data detected by the temperature sensor 221.

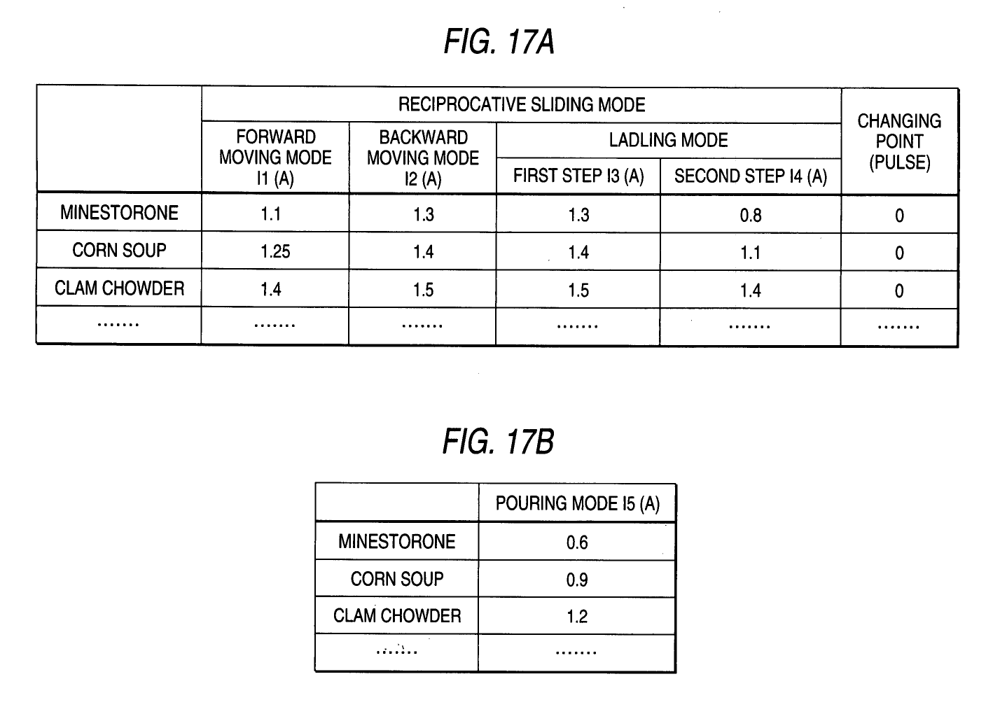

The ROM 203 serves to store table data 203a for sliding (hereinafter referred to sliding table data 203a) (see FIG. 17A) in which current value data is correlated with each kind of the soup as a sliding mode in which the ladle 11 slides over the inner periphery of the vessel 5. The current value data is transmitted to the driving motor controller 280 by the CPU 201.

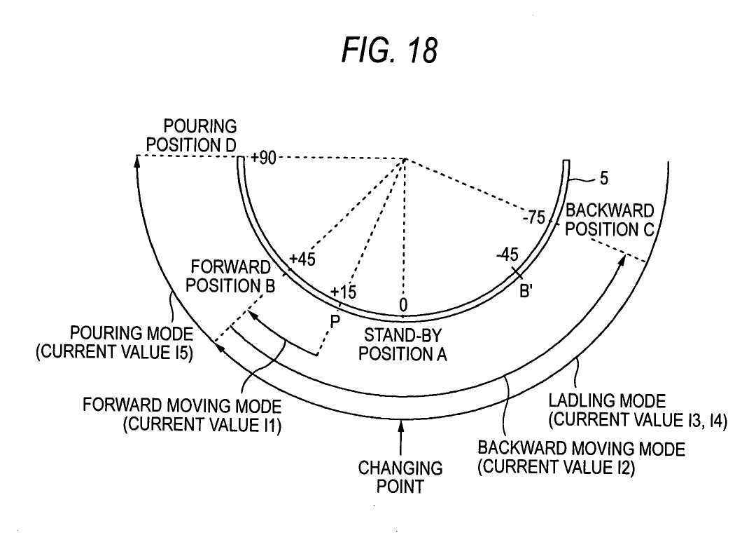

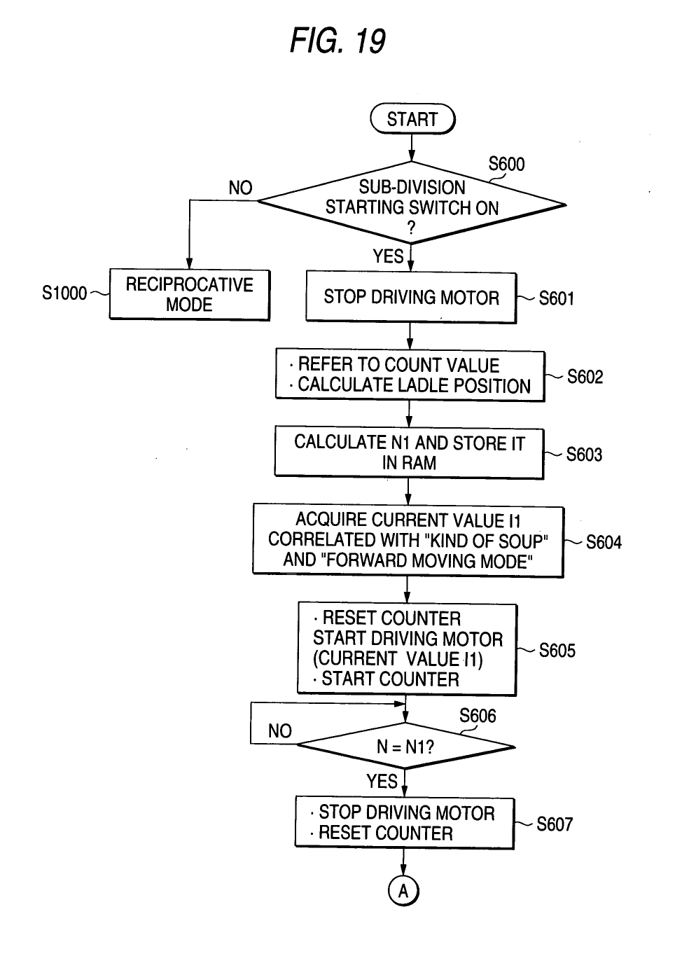

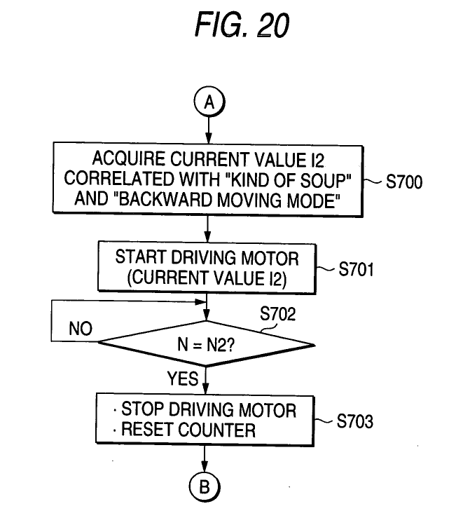

Incidentally, the sliding mode in the embodiment includes a forward moving mode in which the ladle 11 moves to a forward position B (FIG. 18), a backward moving mode in which the ladle 11 moves from the forward position B to a backward position C (FIG. 18) and a ladling mode in which the ladle 11 moves from the backward position C to the forward position B. As illustrated in FIG. 17A, on the sliding table data 203a, for each kind of the soup, the current value corresponding to the rotary speed of the driving motor 28 is correlated with the forward moving mode, backward moving mode and ladling mode, respectively. Further, the current value in the ladling mode is set in e.g. two steps so that the ladle 11 moves at a lower speed as it approaches the forward position B. The data of the position (changing point) where the speed in the two steps is changed is also correlated for each kind of the soup on the sliding table data 203a.

The ROM 203 serves to store table data 203b for pouring (hereinafter referred to pouring table data 203a) (see FIG. 17B) in which current value data is correlated with each kind of the soup as a pouring mode in which the ladle 11 moves from forward position B of the vessel 5 to pouring position D (FIG. 18). The current value data is transmitted to the driving motor controller 280 by the CPU 201.

Incidentally, the current values on the sliding table data 203a and pouring table data 203b can be set from setting buttons on the control panel 31.

Further, the RAM 205 serves to store data of the kind of the soup and other data set by e.g. suitably operating the setting buttons 33.

The micro-switch 281 is provided as required so that it turns on when the ladle 11 is brought into contact with e.g. the driving linkage piece 30 at stand-by position A (FIG. 18). This provides a signal at the base point from which the number of pulses of the driving motor 28 is counted.

In the soup supplying apparatus configured as described hitherto, an explanation will be given of the operation of stirring or ladling the soup accommodated in the vessel 5 prior to pouring it, the operation referred to as a sliding mode.

First, it is assumed that the following preparations are made. On the basis of the quantity of the ingredients contained in the soup, the ratio between the ingredients and the soup liquid of the soup to be ladled up by the ladle 11 is determined. According to the ratio thus determined, the partitioning plate 38 is fit in one of the partitioning plate fitting portions 11c at the plurality of positions of the ladle 11. Next, the linkage mechanism 8 with the ladle 11 mounted is put in the vessel 5 so that the rotary shaft 9 of the linkage mechanism 8 is attached to the U-shaped grooves 6 provided on the sides 5c of the vessel 5. Subsequently, the soup is poured into the vessel 5 and accommodated therein.

Incidentally, in the embodiment, it is assumed that the soup accommodated in the vessel 5 is being stirred in such a manner that the ladle 11 reciprocatively slides timely between predetermined positions on the inner periphery of the vessel 5 (hereinafter, the state is referred to as “reciprocative mode”) Namely, the ladle 11 reciprocatively slides between e.g. predetermined positions B and B′ (FIG. 18) in the vessel 5 to stir the soup in the vessel 5 in such a manner that the CPU 201 inverts the polarity of the driving motor 28 and repeats the reset and start of the counter 207.

As shown in FIG. 13, in a forward moving mode, the CPU 201 determines the ON/OFF state of the sub-division switch 32 located on the control panel (S600). If it is determined that the sub-division switch 32 is OFF (S600: NO), the CPU 201 continues the operation in the above reciprocative mode (S1000).

If it is determined that the sub-division switch 32 is ON (S600: YES), the CPU 201 causes the driving motor control portion 280 to stop the driving motor 28 (S601).

Referring to the count value in the counter 207 which has been counting the number of pulses with the rotation of the driving motor 28, the CPU 201 calculates as required the position of the ladle 11 on the basis of the count value and the polarity of the driving motor 28 (S602). This position is defined as follows. For example, it is assumed that the ladle 11 is located at position P indicated in FIG. 18. If the position P is a position where the driving motor 28 has rotated by 15 (fifteen) pulses from the stand-by position A, it is expressed as “+15 pulses”. Incidentally, the sign “+” representative of the polarity corresponds to the direction in which the driving motor 28 rotates to slide the ladle 11 forward from the back.

Further, the CPU 201 calculates the number of pulses N1 (45−15=30 pluses) corresponding to the rotary quantity of the driving motor 28 from the position P (+15 pulses) to the forward position B (e.g. +45 pulses) and causes the RAM 205 to store the number of pulses N1 (S603).

Referring to the sliding table data 203a stored in the ROM 203, the CPU 201 acquires the current value I1 which is correlated with the kind of the soup stored in the RAM 205 and the forward moving mode (S604).

The CPU 201 resets the counter 207, causes the driving motor control portion 280 to supply the current having the current value I1 with the polarity of “+” to the driving motor 28, and causes the counter 207 to start to count the number of pulses in the driving motor 28 (S605).

Next, referring to the count value N of the counter 207, the CPU 201 determines whether or not the count value N has reached the number of pulses N1 (=30) stored in the RAM 205 (S606).

If it is determined that N is equal to N1 (S606: YES), the CPU 201 stops the driving motor 28 and resets the counter 207 (S607) to proceed to the operation in the backward moving mode described later (S700).

Incidentally, the time from when the driving motor 28 has been stopped in step S301 to when it is started in step S605 can be set at a predetermined time (e.g. 0.5 sec) using a timer 209 as required.

As indicated by an arrow in FIG. 18, in the forward moving mode, when the sub-division switch 32 is depressed, the ladle 11 stops at the position P for e.g. 0.5 sec. and thereafter slides from the position P to the forward position B at the speed equal to e.g. that in the case of the reciprocative moving mode. This speed can be realized by setting the current value I1 correlated with the forward moving mode on the sliding table data 203 at the current value in the reciprocative mode.

As shown in FIG. 14, in the backward moving mode, referring to the sliding table data 203a, the CPU 201 acquires the current value I2 which is correlated with the kind of the soup and the backward moving mode (S700).

The CPU 201 causes the driving motor control portion 280 to supply the current having the current value I2 with the polarity of “−” to the driving motor 28, and causes the counter 207 to start to count the number of pulses in the driving motor 28 (S701).

Next, referring to the count value N of the counter 207, the CPU 201 determines whether or not the count value N has reached the number of pulses N2 (=120) (S702). Incidentally, the number of pulses N2 (=120) corresponds to the rotary quantity of the driving motor 28 from the forward position B (+45 pulses) to the backward position C (e.g. −75 pulses).

If it is determined that N is equal to N2 (S702: YES), the CPU 201 stops the driving motor 28 and resets the counter 207 (S703) to proceed to the operation in the ladling mode described later (S800).

Incidentally, the time from when the driving motor 28 has been stopped in above step S607 to when it is started in step S701 can be set at a predetermined time (e.g. 0.5 sec) using the timer 209 as required.

As indicated by an arrow in FIG. 18, in the backward moving mode, the ladle 11 stops at the forward position B for e.g. 0.5 sec. and thereafter slides from the forward position B to the backward position C at the speed higher than to e.g. that in the case of the above forward moving mode. This speed can be realized by setting the current value I2 correlated with the backward moving mode on the sliding table data 203 at a current value larger than the current value I1 correlated with the forward moving mode.

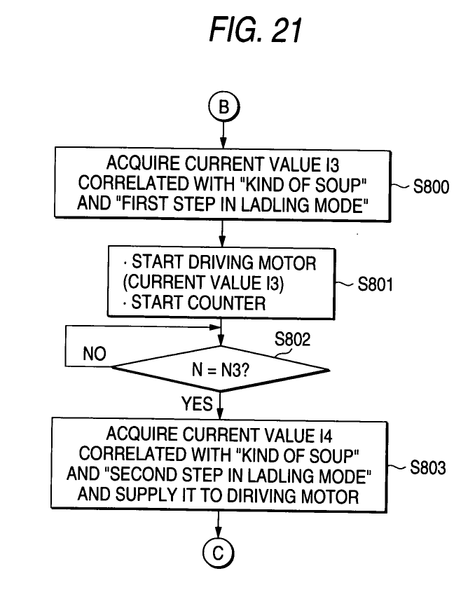

As shown in FIG. 21, in the ladling mode, referring to the sliding table data 203a, the CPU 201 acquires the current value 13 which is correlated with the kind of the soup and the first step of the ladling mode (S800). The CPU 201 causes the driving motor control portion 280 to supply the current having the current value I3 with the polarity of “+” to the driving motor 28, and causes the counter 207 to start to count the number of pulses in the driving motor 28 (S801). Next, referring to the count value N of the counter 207, the CPU 201 determines whether or not the count value N has reached the number of pulses N3 (=75) (S802). Incidentally, the number of pulses N3 (=75) corresponds to the rotary quantity of the driving motor 28 from the backward position C (−75 pulses) to the stand-by position A (0 pulse).

If it is determined that N is equal to N3 (S802: YES), referring to the sliding table data 203a, the CPU 201 acquires the current value I4 which is correlated with the kind of the soup and the second step of the ladling mode (S800). The CPU 201 also causes the driving motor control portion 280 to supply the current having the current value I4 with the polarity of “+” to the driving motor 28 (S803) to proceed to the operation in the pouring mode (S900).

Incidentally, the time from when the driving motor 28 has been stopped in above step S703 to when it is started in step S801 can be set at a predetermined time using the timer 209 as required. Further, the predetermined time may be correlated with the kind of the soup on the sliding table data 203a so that it is variable according to the kind of the soup.

As indicated by an arrow in FIG. 18, in the ladling mode, the ladle 11 stops at the backward position C for a predetermined time and thereafter slides from the backward position C to the stand-by position A at the speed equal to e.g. that in the case of the above backward moving mode. In addition, after the ladle 11 has reached the stand-by position A, it slides from the stand-by position A to the forward position B at the speed lower than e.g. the preceding speed. Namely, in the embodiment, the stand-by position A is a point of changing the speed of the driving motor 28. As described previously, the data on the changing point is correlated with the kind of the soup. In the embodiment, the speed before the changing point can be realized by setting the current value I3 correlated with the first step of the ladling mode on the sliding table data 203a at a current value equal to the current value I2 correlated with the above backward moving mode. The speed after the changing point can be realized by setting the current value I4 correlated with the second step of the ladling mode on the sliding table data 203a at a smaller value than the current value I3 correlated with the first step.

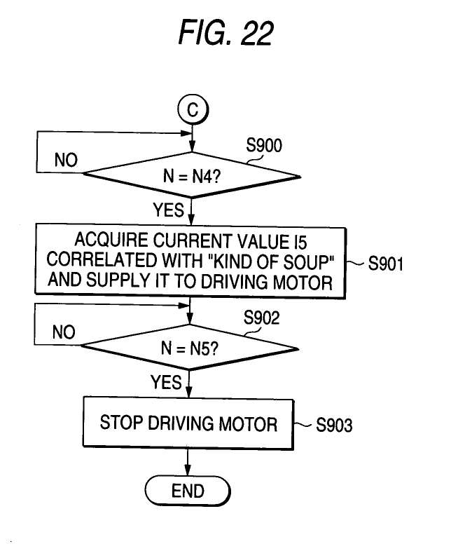

As shown in FIG. 22, in the pouring mode, referring to the count value N of the counter 207 in the above ladling mode, the CPU 201 determines whether or not the count value N has reached the number of pulses N4 (=120) (S900). Incidentally, the number of pulses N4 (=120) corresponds to the rotary quantity of the driving motor 28 from the backward position C (−75 pulses) to the forward position C (+45 pulses).

If it is determined that N is equal to N4 (S900: YES), referring to the pouring table data 203b, the CPU 201 acquires the current value I5 which is correlated with the kind of the soup and causes the driving motor control portion 280 to supply the current having the current value I5 with the polarity of “+” to the driving motor 28 (S901).

Next, referring to the count value N of the counter 207, the CPU 201 determines whether or not the count value N has reached the number of pulses N5 (=165) (S902). Incidentally, the number of pulses N5 (=165) corresponds to the rotary quantity of the driving motor 28 from the backward position C (−75 pulses) to pouring position D (+90 pulses).

If it is determined that N is equal to N5 (S902: YES), the CPU 201 stops the driving motor 28 (S903).

Incidentally, the time from when the driving motor 28 has been stopped in above step S603 to when it is started again can be set at a predetermined time using the timer 209 as required. This predetermined time may be correlated with the kind of the soup on the pouring table data 203a so that it is variable according to the kind of the soup.

As indicated by an arrow in FIG. 18, in the pouring mode, the ladle 11 slides from the forward position B to the pouring position D at the speed lower than that in the case of the above ladling mode. Thus, the soup is poured out from the ladle 11. Incidentally, the speed can be realized by setting the current value I5 on the pouring table data 203b at a value smaller than the current value I4 correlated with the second step of the ladling mode.

By the operation by the CPU 201, the following operation of the soup supplying apparatus will be implemented.

With the eating utensil 16 placed on the eating utensil placing portion 3, when a sub-division starting switch 32 on the control panel 31 is operated, the sub-division operation of the soup is started. Concretely, when the driving motor 28 of the driving apparatus 26 is energized, the linkage mechanism 8 once rotates through the driving linkage piece 30 in the direction of the opening 11a of the ladle 11 from the position P indicated in FIG. 18, and thereafter rotates in the direction opposite to the opening 11a.

As shown in FIG. 9A, when the linkage mechanism 8 rotatively moves to a predetermined position (e.g. position inclined by 45 degrees backwards), it starts to rotatively move in the opening 11a direction of the ladle 11. At the time, the ladle 11 makes the arc movement along the bottom 5b of the vessel 5 in sliding-contact therewith, thereby accommodating the soup into the soup accommodating portion 11b from the opening 11a. Here, the soup accommodated in the soup accommodating portion 11b is accumulated at a predetermined ratio between the ingredients and soup liquid by the partitioning plate 38.

Further, when the rotation further proceeds, as shown in FIG. 9B, the ladle 11 is inserted into the wide mouth 40a of the hopper 40 which is formed to lead to the arc-shaped bottom 5b of the vessel 5.

When the linkage mechanism 8 further rotatively moves, the ladle 11, while being inserted in the hopper 40 and integral thereto, around the supporting shaft 41 journaling the hopper 40, rotatively moves over the opening 5b of the vessel 5 to the outside thereof as shown in FIG. 9C. Thus, the soup within the ladle 11 is poured into the eating utensil 16 placed on the eating utensil placing portion 3. At the time, since the partitioning plate 38 within the ladle 11 rotatively moves toward the opening 11a to open owing to the pushing force by the pouring soup. As a result, all the ingredients/dregs as well as the soup liquid proceeded in the inner part of the soup accommodating portion 11b are discharged.

Further, in the case, the soup accommodated within the soup accommodating portion 11b of the ladle 11 is poured into the eating utensil 16 in a nearly constant state through the hopper 40 from its cylindrical mouth 40b. When the whole soup accommodated in the soup accommodating section 11b has been sub-divided into the eating utensil 16, the linkage mechanism 8 is rotated in an opposite direction so that the ladle 11 is returned into the vessel 5 again. Such an operation is repeated as required so that predetermined quantities of soup are sub-divided from the vessel 5 into the eating utensils 16.

Incidentally, the vessel cover 20 covering the opening 5a of the vessel 5 is normally closed. The vessel cover 20 is provided with a pouring mouth door 20a which is opened owing to pushing force resulting when the ladle 11, while being inserted in the hopper 40 and integral thereto, rotatively moves over the opening 5b of the vessel 5 to the outside thereof.

Meanwhile, the ladle 11 is provided with a partitioning plate 38 for passing the soup liquid without passing the ingredients mixed in the soup, the partitioning plate being arranged to partition the internal soup accommodating portion 11b into an opening 11a side and an inner side. Further, the partitioning plate 38 is released when the soup ladled in the soup accommodating portion 11b is poured out from the opening 11a. For the reason, even where the soup accommodated in the soup accommodating portion 11b mixedly contains fine ingredients/dregs or extracts passing the partitioning plate 38 and these ingredients/dregs proceed into the inner part of the soup accommodating portion 11b, when the soup within the soup accommodating portion 11b is poured out from the opening 11a, the ingredients/dregs or extracts as well as the soup liquid flow toward the opening 11a from the inner part of the ladle 11 and are poured out from the opening to the outside. Thus, these ingredients/dregs or extracts do not accumulate within the soup accumulating portion 11b so that the volume at the inner part of the soup accommodating portion is not reduced. Accordingly, the ingredients and soup liquid ladled up at a predetermined ratio can be sub-divided into the eating utensil.

Further, since the partitioning plate 38 with its one end journaled is rotatably configured, when the soup ladled into the soup accommodating portion 11b is poured out from the opening 11a, the partitioning plate 38 rotatatively moves toward the opening 11a so that partitioning within the soup accommodating portion 11b is easily released. Thus, the partition of the soup accommodating portion 11b can be configured at low cost.

Further, the partitioning plate 38 is journaled at its upper part with the position of center of gravity being close to the opening 11a and is provided with a stopper section 38d for preventing rotation toward the inner part. Thus, the partitioning plate 38, while being rotatively urged to the inner part of the soup accommodating section 11b, is kept at the partitioning position so that even when the opening 11a is inclined downward while the ladle 11 rotatively moves backward in the vessel, the partitioning plate 38 does not easily rotatively move toward the opening 11a. This prevents the partitioning plate 38, on the way of the rotative movement of the ladle, from being released so that a large amount of ingredients do not proceed into the inner part of the soup accommodating portion 11b.

The ingredients and soup liquid always ladled up at a predetermined ratio therebetween can be sub-divided into the eating utensil.

The rear of the ladle 11 on the side opposite to the opening 11a is formed to protrude rearward in a wedge shape. Therefore, when the ladle 11 rotatively moves rearward, it does not stir the ingredients mixed in the soup within the vessel 5 to prevent the ingredients from being scooped up onto the outer fence of the ladle 11. Namely, since the quantity of the ingredients mixed in the soup within the vessel 5 is not reduced, when the ladle 11 rotatively moves toward the opening 11a to ladle or scoop up the soup, it can effectively ladle the ingredients.

In the way, in accordance with the soup supplying apparatus according the embodiment, even where the soup accommodated in the apparatus mixedly contains fine ingredients/dregs passing the partitioning plate 38 as well as the ingredients that can be separated by the partitioning plate 38 of the ladle 11, it is possible to prevent the ingredients/dregs and extracts from accumulating within the ladle 11, thereby always scooping up the ingredients and soup liquid in a predetermined ratio therebetween to be sub-divided into the eating utensil when the soup within the vessel 5 is ladled by the ladle 11.

In the sliding table data 203a (FIG. 17A) and the pouring table data 203b (FIG. 17B) according to the embodiment, the current value I5 giving the second driving force in the pouring mode is set at a smaller value than the current values I1 to I4 giving the first driving force in the above reciprocative sliding (reciprocative mode) or the ladling-sliding (sliding mode). Thus, the inertial force which acts on the soup is restrained until the ladle 11 stops at the pouring position D (FIG. 18). Accordingly, the soup can be sub-divided while being sufficiently stirred or ladled but without being splashed.

Particularly, the ratio of reducing the current I5 to the current I4 is set to be larger in the case of e.g. minestrone with less thickness than in the case of e.g. clam chowder with more thickness. Thus, the soup with less thickness which is prone to be splashed by the inertial force in sub-division is poured out at a relatively low speed by the ladle 11 so that it is prevented from being splashed. On the other hand, the soup with more thickness which is difficult to be splashed is poured out at a relatively high speed by the ladle 11 so that it can be sub-divided promptly.

Further, in the sliding table data 203a according to the embodiment, the current value I4 at the second step of the ladling mode is set to be smaller than the current value I3 at the first step thereof. Particularly, the reducing rate is set to be larger in the case of e.g. minestrone with less thickness than in the case of e.g. clam chowder with more thickness. Thus, the ladle 11 is decelerated at the stand-by position A (FIG. 18) which is a changing point so that the inertial force which acts on the soup is restrained until the ladle 11 stops at the pouring position D (FIG. 18).

In the backward moving mode according to the embodiment, the entire soup is stirred. Thus, the soup sub-divided has a predetermined quantity of ingredients for each vending, thereby keeping its quality. Further, in the backward moving mode, e.g. the ingredients/dregs or extracts within the ladle 11, which are located at the backward position C (FIG. 18) higher than the amplitude BB′ of the reciprocative mode, are more likely to fall into soup within the vessel 5 and hence are difficult to accumulate within the ladle 11. This removes the fear of relatively reducing the quantity of the soup liquid within the ladle 111 owing to such ingredients/dregs or extracts, thereby keeping the quality of the soup. Further, on the sliding table data 203a, the current value I2 is set to be larger in order of the soup with more thickness (clam chowder, corn soup and minestrone). Therefore, the driving force of the ladle 11 in the backward moving mode is larger for e.g. clam chowder with more thickness than for e.g. minestrone with less thickness. Thus, for the soup with more thickness, through which the operation of the ladle 11 is difficult to conduct, the entirety thereof can be stirred immediately before the sub-division. Accordingly, the soup with more thickness can keep its quality as in the case of the soup with less thickness.

Incidentally, it is needless to say that the invention should not be limited to the apparatus given by the second embodiment and can be modified within a scope including the intention of the invention.

In the second embodiment described above, in the pouring mode, the position where the ladle 11 starts to decelerate is set at the forward position B (FIG. 18), but should not be limited to it. For example, the ladle 11 may be decelerated at the position where while being integral to the hopper 40, the hopper 40 starts around the supporting shaft 41 to rotatively move over the opening 5b of the vessel 5 to the outside thereof (FIGS. 9B and 9C). Thus, at least, the speed at which the hopper 40 rotatively moves around the supporting shaft 41 is reduced, thereby making the soup difficult to be splashed during its sub-division. Further, the sliding mode in the embodiment described above includes the forward moving mode, backward moving mode and ladling mode, but should not be limited to them. For example, the sliding mode may include only the ladling mode. Specifically, when a supplying command for the soup is issued while the ladle 11 in the reciprocative mode is sliding forward in FIG. 12, the ladle 11, as its is, may be slid to the position immediately in front of the position where the hopper 40 starts to rotatively move (ladling mode) and decelerated. Further, when a supplying command for the soup is issued while the ladle 11 in the reciprocative mode is sliding backward in FIG. 18, the ladle 11 may be returned at the position when the command has been issued to slide to the position immediately in front of the position where the hopper 40 starts to rotatively move (ladling mode), and decelerated.

In the embodiment described above, the changing point of the speed of the driving motor 28 in the ladling mode is set at the stand-by position A, but should not be limited to it. For example, the changing point may be any position between the stand-by position A and forward position B.

Further, in the second embodiment described above, the current value in the ladling mode is set at two steps, but should not be limited to them. The current value is preferably set at three or more steps so that the driving force decreases as the ladle 11 approaches the forward position B. In the way, the inertial force acting on the soup can be effectively reduced so that the soup can be sub-divided without being splashed.

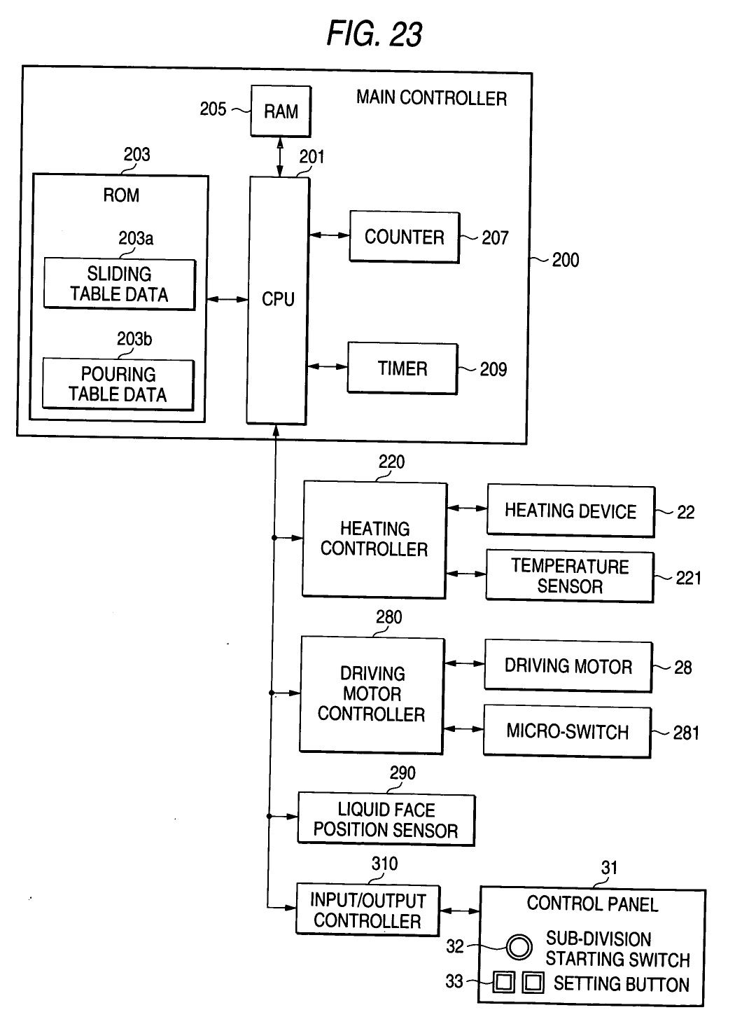

Furthermore, in the soup supplying apparatus described above, the ladle 11 is slid to fixed positions, but should not be limited to them. For example, as shown in FIG. 23, the soup supplying apparatus may include a liquid face position sensor (remaining level detecting unit) 290 for detecting the height of the liquid face of the soup within the vessel 5. The liquid face position sensor 290 timely transmits the data on the height of the liquid face to the CPU 201. Assuming that the CPU 201 sets the forward position B, position B′, backward position C, etc. according to the height of the liquid face of the soup, the ladle 11 can be slid within the remaining level all the time. Further, even where the liquid face position sensor 290 is not employed, the number of times of vending, each corresponding to the volume of the ladle may be subtracted from the initial level of the soup to calculate the remaining level of the soup, and using the remaining level, the above forward position B and others may be calculated. In the case, the initial level of the soup and quantity thereof vended once may be parameters in a suitable program for executing the above calculations, and the number of times of vending may be those when the sub-division starting switch 32 issues an ON signal. This number of times is counted by a counter included in the main controller 200. In the way, the soup can be stirred or ladled by the minimum sliding of the ladle 11 corresponding to the remaining level thereof. This reduces the running cost of the soup supplying apparatus.

The driving motor 28 in the embodiment described above is a DC motor equipped with a rotary encoder, but without being limited to it, may be a stepping motor. In the case, it should be noted that the rotary speed of the stepping motor can be controlled by changing the frequency in exciting a plurality of exciting coils in order. Therefore, the higher frequency, and hence higher speed of the rotary speed of the driving motor correspond to larger driving force.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A soup supplying apparatus comprising:
a vessel that accommodates a soup and has an arc-shaped inner periphery and an upper opening formed at one end of the inner periphery;
a ladle mechanism that ladles up the soup accommodated in the vessel by slidably moving along the inner periphery toward the upper opening and pours the soup out from the vessel through the upper opening;
a driving device having a variable speed motor that supplies a driving force to the ladle mechanism; and
a controller that controls the driving device,
wherein the controller controls the driving device to move the ladle mechanism to reciprocatively slide between predetermined positions on the inner periphery of the vessel when in a mode of not pouring out the soup, and
wherein the controller controls the driving device to vary speed of the movement of the ladle mechanism in accordance with a kind of the soup accommodated in the vessel.

2. A soup supplying apparatus comprising:
a vessel that accommodates a soup and has an arc-shaped inner periphery and an upper opening formed at one end of the inner periphery, the vessel configured to be heatable;
a ladle mechanism that ladles up the soup accommodated in the vessel by slidably moving along the inner periphery towards the upper opening and pours the soup out from the vessel through the upper opening;
a driving device that supplies a driving force to the ladle mechanism; and
a controller that controls the driving device,
wherein the controller controls the driving device to move the ladle mechanism to reciprocatively slide between predetermined positions on the inner periphery of the vessel when in a mode of not pouring out the soup, and
wherein the controller is coupled to a temperature sensor such that the controller is adapted to control the driving device to vary speed of the movement of the ladle mechanism in accordance with a temperature of the soup accommodated in the vessel when the vessel is heated.

3. The soup supplying apparatus according to claim 2, wherein the controller controls the driving device to increase the speed of the movement of the ladle mechanism as the temperature of the soup arises when in the mode of not pouring out the soup.

4. The soup supplying apparatus according to claim 2, wherein the controller controls the driving device to stop the movement of the ladle mechanism when the temperature of the soup is not higher than a predetermined temperature when in the mode of not pouring out the soup.

5. A soup supplying apparatus comprising:
a vessel that accommodates a soup and has an arc-shaped inner periphery and an upper opening formed at one end of the inner periphery, the vessel configured to be heatable;
a ladle mechanism that ladles up the soup accommodated in the vessel by slidably moving along the inner periphery towards the upper opening and pours the soup out from the vessel through the upper opening;
a driving device that supplies a driving force to the ladle mechanism; and
a controller that controls the driving device,
wherein the controller controls the driving device to move the ladle mechanism to reciprocatively slide between predetermined positions on the inner periphery of the vessel when in a mode of not pouring out the soup, and
wherein the controller is coupled to at least one counter such that the controller can control the driving device to vary frequency of the movement of the ladle mechanism in accordance with a temperature of the soup accommodated in the vessel when the vessel is heated.

6. The soup supplying apparatus according to claim 5, wherein the controller controls the driving device to increase the frequency of the movement of the ladle mechanism as the temperature of the soup arises when in the mode of not pouring out the soup.

7. A soup supplying apparatus comprising:
a vessel that accommodates a soup and has an arc-shaped inner periphery and an upper opening formed at one end of the inner periphery;
a ladle mechanism that ladles up the soup accommodated in the vessel by slidably moving along the inner periphery towards the upper opening and pours the soup out from the vessel through the upper opening;
a driving device that supplies a driving force to the ladle mechanism; and
a controller that controls the driving device,
wherein the controller includes a memory having reciprocative sliding table data and end sliding table data, such that the controller is adapted to control the driving device to repeat a first and a second operations when in a mode of not pouring out the soup, the first operation in which to move the ladle mechanism to reciprocatively slide between predetermined positions on the inner periphery of the vessel, the second operation in which to move the ladle mechanism to move the ladle mechanism toward the other end of the inner periphery outside the predetermined positions.

8. The soup supplying apparatus according to claim 7, wherein the controller controls the driving device to vary speed of the movement of the ladle mechanism in accordance with a kind of the soup accommodated in the vessel in the second operation.

9. The soup supplying apparatus according to claim 7, wherein the controller controls the driving device to vary frequency of the movement of the ladle mechanism in accordance with a kind of the soup accommodated in the vessel in the second operation.

10. The soup supplying apparatus according to claim 7, where in the controller controls the driving device to temporarily stop the movement of the ladle mechanism when the ladle mechanism is moved at the other end of the inner periphery outside the predetermined positions.

11. The soup supplying apparatus according to claim 10, wherein the controller controls the driving device to vary at a time period to stop the movement of the ladle mechanism at the other end of the inner periphery outside the predetermined positions.

12. A soup supplying apparatus comprising:
a vessel that accommodates a soup and had an arc-shaped inner periphery and an upper opening formed at one end of the inner periphery;
a ladle mechanism that ladles up the soup accommodated in the vessel by slidably moving along the inner periphery towards the upper opening and pours the soup out from the vessel through the upper opening;
a driving device that supplies a driving force to the ladle mechaisnm; and
a controller that controls the driving device to supply to the ladle mechanism a first driving force for reciprocatively sliding the ladle mechanism between predetermined positions on the inner periphery of the vessel, and a second driving force for moving the ladle mechanism to pour out the soup from the vessel,
wherein the second driving force is configured to be smaller than the first driving force.

13. The soup supplying apparatus according to claim 12, wherein the controller controls the driving device to vary the second driving force in accordance with a thickness of the soup.

14. A soup supplying apparatus comprising:
a vessel that accommodates a soup and has an arc-shaped inner periphery and an upper opening formed at one end of the inner periphery;
a ladle mechanism that ladles up the soup accommodated in the vessel by slidably moving along the inner periphery towards the upper opening and pours the soup out from the vessel through the upper opening;
a driving device that supplies a driving force to the ladle mechanism; and
a controller that controls the driving device to supply to the ladle mechanism a first driving force for reciprocatively sliding the ladle mechanism between predetermined positions on the inner periphery of the vessel, and a second driving force for moving the ladle mechanism to pour out the soup from the vessel,
wherein the controller controls the driving device to reduce the first driving force as the ladle mechanism approaches the one end of the inner periphery of the vessel.

15. The soup supplying apparatus according to claim 14, wherein the controller controls the driving device to vary a ratio of reducing the first driving force in accordance with a thickness of the soup.

16. The soup supplying apparatus according to claim 14, wherein the second driving force is configured to be smaller than the first driving force.

17. A soup supplying apparatus comprising:
a vessel that accommodates a soup and has an arc-shaped inner periphery and an upper opening formed at one end of the inner periphery;
a ladle mechanism that ladles up the soup accommodated in the vessel by slidably moving along the inner periphery towards the upper opening and pours the soup out from the vessel through the upper opening;
a driving device that supplies a driving force to the ladle mechanism;
a micro switch provided at a bottom portion of the arc-shaped inner periphery of the vessel, the micro switch being adapted to stop the driving device; and
a controller that controls the driving device to move the ladle mechanism towards the other end of the inner periphery before moving the ladle mechanism towards the one end when a command to supply the soup is input.

18. The soup supplying apparatus according to claim 17, wherein the controller controls the driving device to vary the driving force to move the ladle mechanism towards the other end of the inner periphery in accordance with a thickness of the soup.

19. The soup supplying apparatus according to claim 17, further comprising a remaining level detecting unit that detects a remaining level of the soup accommodated in the vessel, wherein a controller controls the driving device to vary a distance of the movement of the ladle mechanism towards the other end of the inner periphery in accordance with the remaining level detected by the remaining level detecting unit.
